(19) United States
(12) Patent Application Publication
(10) Pub. No.: US 2024/0054548 A1
(43) Pub. Date: Feb. 15, 2024

(54) UTILIZING MACHINE LEARNING MODELS TO GENERATE CUSTOMIZED OUTPUT

(71) Applicant: Golden State Asset Management, LLC, South Coast Metro, CA (US)

(72) Inventors: Daniel Robert Catone, Powell, WY (US); John Emile Nahas, Laguna Beach, CA (US); Patrick Michael Jeffs Catone, Anaheim, CA (US); Clint Patrick Nylander, Powell, WY (US)

(21) Appl. No.: 18/449,150

(22) Filed: Aug. 14, 2023

Related U.S. Application Data
(60) Provisional application No. 63/371,469, filed on Aug. 15, 2022.

(51) Int. Cl. G06Q 30/0601; G06Q 30/0282; G06Q 10/1093; G06Q 30/018

(52) U.S. Cl. CPC G06Q 30/0631; G06Q 30/0282; G06Q 10/1095; G06Q 30/018

(57) ABSTRACT

A service coordination system can receive user data and service provider data and can matching and pairing recommendations pertaining to the users and one or more service providers as well as schedule meetings between the users and service providers and facilitate data exchange between a user and a paired service provider. In some embodiments, machine learning and/or artificial intelligence algorithms can be used to match users with service providers (SPs). Additional communications components are also provided for the users and SPs, once matched or paired.

### PRIORITY AND INCORPORATION BY REFERENCE TO APPLICATION(S)

This application claims priority to U.S. Provisional Patent Application No. 63/371,469 filed on Aug. 15, 2022 and titled “UTILIZING MACHINE LEARNING MODELS TO GENERATE CUSTOMIZED OUTPUT”. The entire content of the above-reference application is hereby expressly incorporated herein by reference in its entirety for all purposes.

### LIMITED COPYRIGHT AUTHORIZATION

A portion of the disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### TECHNICAL FIELD

Embodiments of the present disclosure relate to systems and methods for training and/or applying a machine learning model to generate pairing recommendations pertaining to one or more users and one or more service providers. Embodiments of the present disclosure further relate to pairing and scheduling a user with a service provider based at least in part on one or more criteria. Embodiments of the present disclosure further relate to facilitating meetings between paired individuals.

### SUMMARY

Finding a service provider can be a frustrating and time-consuming endeavor. In many cases, finding a good match with a service provider is essential for a mutually beneficial relationship. However, because many service providers operate on numerous platforms or are not available online consistently or at all, meeting multiple service providers to find the right fit is time-consuming. Meetings might require many in-person visits, phone calls, emails, and the like before a good match is found. Additionally, before committing to a service provider, it may be important to a user of the system to review or at least have considered the service provider's credentials, such as certifications, licenses, personal reviews, years of experience and/or the like. In many cases, this information is not readily available and may not be entirely accurate. The systems, methods, and devices of the present disclosure may overcome one or more of these disadvantages, and may include a new way to match, rank, and/or pair users with service provider(s).

In the financial space, for most people, managing their own investments can be complicated. Many people could benefit from working with a financial advisor to develop a unique strategy that is tailored to their financial situation and goals. However, choosing the right financial advisor is difficult. With so many different options out there, finding the right fit can be time consuming and complicated. Often, people seeking financial services rely on referrals from their friends or are required to conduct research by using the phone book or searching the internet. These options do not always allow a consumer to properly vet the financial advisor or ensure that the financial advisor has the proper expertise they are looking for. The systems, methods, and devices of the present disclosure may overcome one or more of these disadvantages, and may include a new way to find a service provider that is a good match with a particular user.

When searching for a financial advisor, finding the right fit is essential. Often, this requires meeting with numerous advisors before you find the right one. A person may have to travel to different banks or credit unions to meet with multiple advisor. Once a financial advisor is chosen, further difficulties arise with sharing investment history with the advisor and scheduling future consultation appointments.

Embodiments of the system can allow a user to easily match and meet with one or more services providers based on user criteria and service provider criteria. In some embodiments, the system may use the user criteria and/or service provider criteria to identify which service providers are a good match, and schedule and facilitate meetings between users and service providers. In some embodiments, and following the meetings, for example, the user and service provider can agree to be paired and enter a formal relationship.

In one implementation, a computer-implemented method is disclosed. The computer-implemented method may include at least: receiving, from a user device, a user request comprising personal identification information (PII) associated with a first user and user criteria; accessing, from one or more databases, service provider criteria associated with a plurality of service providers; applying, by one or more computer processors, a trained machine learning model to determine a first set of service providers of the plurality of service providers based at least in part on the user request and the service provider criteria; and generating and transmitting, to the user device and by a computer network, presentation instructions configured to cause display of the first set of service providers.

In some implementations, the computer-implemented method further includes: applying threshold criteria to generate a subset of the first set of service providers; and generating and transmitting to the user device and by the computer network, updated presentation instructions configured to cause display of the subset of the first set of service providers. In some implementations, the computer-implemented method further includes: receiving selection of a service provider from the user device. In some implementations, the user criteria includes information and data associated with the first user. In some implementations, the service provider criteria includes information and data associated with the plurality of service providers, wherein each service provider of the plurality of service providers is associated with respective service provider criteria. In some implementations, the training of the machine learning model includes training based on annotated data including electronic information pertaining to successful and/or unsuccessful pairings and annotated data including electronic information pertaining to a magnitude of success or lack of success in the pairings. In some implementations, the computer-implemented method further includes: ranking the subset of the first set of service providers based at least in part on a comparison of the user request and the service provider criteria. In some implementations, the user request further includes one or more time selections. In some implementations, the first set of service providers only includes service providers that are available during one of the one or more time selections. In some implementations, the threshold criteria includes a random selection of a select number of the first set of service providers. In some implementations, the computer-implemented method further includes: sending an alert to the first set of service providers, wherein the threshold criteria includes selecting the subset of the first set of service providers based on any responses received from the first set of service providers to the alert. In some implementations, each service provider in the plurality of service providers has a rating, wherein the rating is based in part on user feedback. In some implementations, the computer-implemented method further includes: scheduling a meeting between the first user and the service provider based on the service provider selection. In some implementations, the meeting includes a video call between the service provider and the first user. In some implementations, an alert is sent to both the service provider and the first user prior to the meeting. In some implementations, the computer-implemented method further includes: receiving a user response, wherein the user response includes a selection of a request to pair with the service provider or a selection of a rejection of the service provider; receiving a service provider response, wherein the service provider response includes a selection of a request to pair with the first user or a selection of a rejection of the first user; and creating a pairing if the user response is a request to pair with the service provider and the service provider response is a request to pair with the first user.

In one implementation, a system including computer-readable memory and one or more computer processors is disclosed. The system may be configured to at least: electronically receive, from a user device, a user request including personal identification information (PII) associated with a first user and user criteria; access, from one or more databases, service provider criteria associated with a plurality of service providers; apply, by one or more computer processors, a trained machine learning model to determine a first set of service providers of the plurality of service providers based at least in part on the user request and the service provider criteria; and generate and electronically transmit, to the user device and by a computer network, presentation instructions configured to cause display of the first set of service providers.

In some implementations, the system is further configured to: apply threshold criteria, to generate a subset of the first set of service providers; and generate and electronically transmit to the user device and by the computer network, updated presentation instructions configured to cause display of the subset of the first set of service providers. In some implementations, the system is further configured to receive selection of a service provider from the user device. In some implementations, the user criteria includes information and data associated with the first user. In some implementations, the service provider criteria includes information and data associated with the plurality of service providers, wherein each service provider of the plurality of service providers is associated with respective service provider criteria. In some implementations, the training of the machine learning model includes training based on annotated data including electronic information pertaining to successful and/or unsuccessful pairings and annotated data including electronic information pertaining to a magnitude of success or lack of success in the pairings. In some implementations, the system is further configured to rank the subset of the first set of service providers based at least in part on a comparison of the user request and the service provider criteria. In some implementations, the user request further includes one or more time selections. In some implementations, the first set of service providers only includes service providers that are available during one of the one or more time selections. In some implementations, the threshold criteria includes a random selection of a select number of the first set of service providers. In some implementations, the system is further configured to: send an alert to the first set of service providers, wherein the threshold criteria includes selecting the subset of the first set of service providers based on any responses received from the first set of service providers to the alert. In some implementations, each service provider in the plurality of service providers has a rating, wherein the rating is based in part on user feedback. In some implementations, the system is further configured to: schedule a meeting between the first user and the service provider based on the service provider selection. In some implementations, the meeting includes a video call between the service provider and the first user. In some implementations, an alert is sent to both the service provider and the first user prior to the meeting. In some implementations, the system is further configured to: receive a user response, wherein the user response includes a selection of a request to pair with the service provider or a selection of a rejection of the service provider; receive a service provider response, wherein the service provider response includes a selection of a request to pair with the first user or a selection of a rejection of the first user; and create a pairing if the user response is a request to pair with the service provider and the service provider response is a request to pair with the first user.

In one implementation, a non-transitory computer storage medium is disclosed. The non-transitory computer storage medium may store computer-executable instructions that, when executed by a processor, cause the processor to at least: electronically receive, from a user device, a user request including personal identification information (PII) associated with a first user and user criteria; access, from one or more databases, service provider criteria associated with a plurality of service providers; apply, a trained machine learning model to determine a first set of service providers of the plurality of service providers based at least in part on the user request and the service provider criteria; and generate and electronically transmit, to the user device and by a computer network, presentation instructions configured to cause display of the first set of service providers.

In some implementations, the computer-executable instructions cause the processor to: apply threshold criteria, to generate a subset of the first set of service providers; and generate and electronically transmit to the user device and by the computer network, updated presentation instructions configured to cause display of the subset of the first set of service providers. In some implementations, the computer-executable instructions cause the processor to: receive, from the user device, selection of a service provider. In some implementations, the user criteria includes information and data associated with the first user. In some implementations, the service provider criteria includes information and data associated with the plurality of service providers, wherein each service provider of the plurality of service providers is associated with respective service provider criteria. In some implementations, the training of the machine learning model includes training based on annotated data including electronic information pertaining to successful and/or unsuccessful pairings and annotated data including electronic information pertaining to a magnitude of success or lack of success in the pairings. In some implementations, the computer-executable instructions cause the processor to: rank the subset of the first set of service providers based at least in part on a comparison of the user request and the service provider criteria. In some implementations, the user request further includes one or more time selections. In some implementations, the first set of service providers only includes service providers that are available during one of the one or more time selections. In some implementations, threshold criteria includes a random selection of a select number of the first set of service providers. In some implementations, the computer-executable instructions cause the processor to: send an alert to the first set of service providers, wherein the threshold criteria includes selecting the subset of the first set of service providers based on any responses received from the first set of service providers to the alert. In some implementations, each service provider in the plurality of service providers has a rating, wherein the rating is based in part on user feedback. In some implementations, the computer-executable instructions cause the processor to: schedule a meeting between the first user and the service provider based on the service provider selection. In some implementations, the meeting includes a video call between the service provider and the first user. In some implementations, the techniques described herein relate to a non-transitory computer storage medium, wherein an alert is sent to both the service provider and the first user prior to the meeting. In some implementations, the computer-executable instructions cause the processor to: receive a user response, wherein the user response includes a selection of a request to pair with the service provider or a selection of a rejection of the service provider; receive a service provider response, wherein the service provider response includes a selection of a request to pair with the first user or a selection of a rejection of the first user; and create a pairing if the user response is a request to pair with the service provider and the service provider response is a request to pair with the first user.

### BRIEF DESCRIPTION OF THE DRAWINGS

The systems, methods, and devices described herein each have several aspects, no single one of which is solely responsible for its desirable attributes. Without limiting the scope of this disclosure, several non-limiting features will now be described briefly. Also, the foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure.

Throughout the drawings, reference numbers are re-used to indicate correspondence between referenced elements. The drawings are provided to illustrate embodiments of the subject matter described herein and not to limit the scope thereof. Specific embodiments will be described with reference to the following drawings.

FIG. 1 is an overall system diagram illustrating an embodiment of a service coordination environment when matching a user and a service provider using a service coordination system and providing services to a user.

FIG. 2 illustrates an embodiment of a service coordination system and system subcomponents.

FIG. 3A illustrates a swim-lane flow diagram of an example method for a user to match with and/or create a pairing with a service provider using an embodiment of a service coordination system.

FIG. 3B illustrates a swim-lane flow diagram of an example method of a user/service provider matching process showing process for an unselected service provider using an embodiment of a service coordination system.

FIG. 3C illustrates a swim-lane flow diagram of an example method of a user/service provider matching process showing the process where no service providers accepted an invite notification using an embodiment of a service coordination system.

FIG. 4 shows a flow diagram illustrating an embodiment of a matching and/or pairing process of a user and a service provider from a user's perspective.

FIG. 5 shows a flow diagram illustrating an embodiment of a matching and/or pairing process of a user and a service provider from a service provider's perspective.

FIG. 6A shows a flow diagram illustrating an embodiment of a matching and/or pairing process of a user and a service provider from the perspective of a service coordination system.

FIG. 6B shows a flow diagram illustrating an embodiment of a matching and/or pairing process of a user and a service provider from the perspective of a service coordination system (for example, when a meeting is canceled).

FIG. 7 illustrates an embodiment of a computing system which may implement example embodiments of one or more components of the service coordination system.

### DETAILED DESCRIPTION

Embodiments of the disclosure will now be described with reference to the accompanying figures. The terminology used in the description presented herein is not intended to be interpreted in any limited or restrictive manner, simply because it is being utilized in conjunction with a detailed description of embodiments of the disclosure. Furthermore, embodiments of the disclosure may include several novel features, no single one of which is solely responsible for its desirable attributes, or which is essential to practicing the embodiments of the disclosure herein described. For purposes of this disclosure, certain aspects, advantages, and novel features of various embodiments are described herein. It is to be understood that not necessarily all such advantages may be achieved in accordance with any particular embodiment. Thus, for example, those skilled in the art will recognize that one embodiment may be carried out in a manner that achieves one advantage or group of advantages as taught herein without necessarily achieving other advantages as may be taught or suggested herein.

### A. Service Coordination Environment

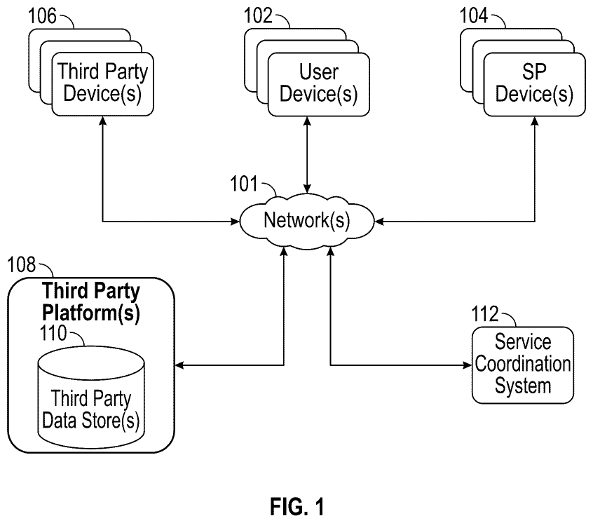

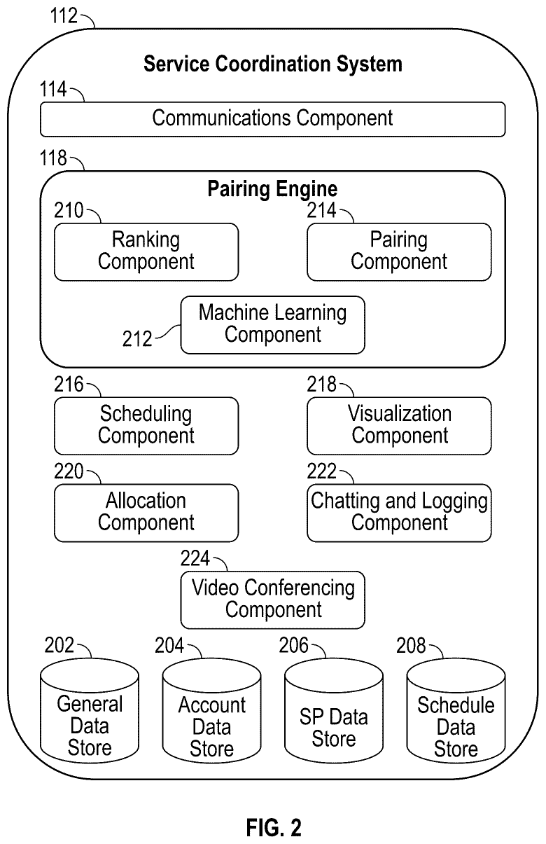

FIG. 1 is an overall system diagram illustrating an embodiment of a service coordination environment 100 for matching and/or pairing users and service providers using a service coordination system 112. The environment 100 can include user device(s) 102, service provider (SP) device(s) 104, third party device(s) 106, and third-party platform(s) 108 in communication over network 101 with service coordination system 112. Service coordination system 112 may include one or more subsystems and/or subcomponents. Embodiments of service coordination system 112 will be further described with reference to FIG. 2.

a) User Device(s)

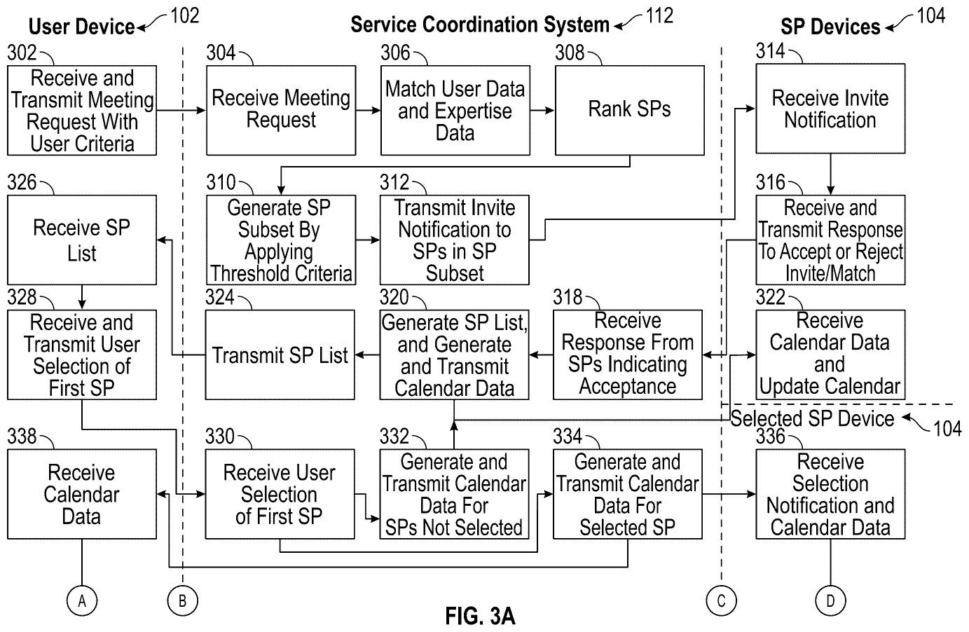

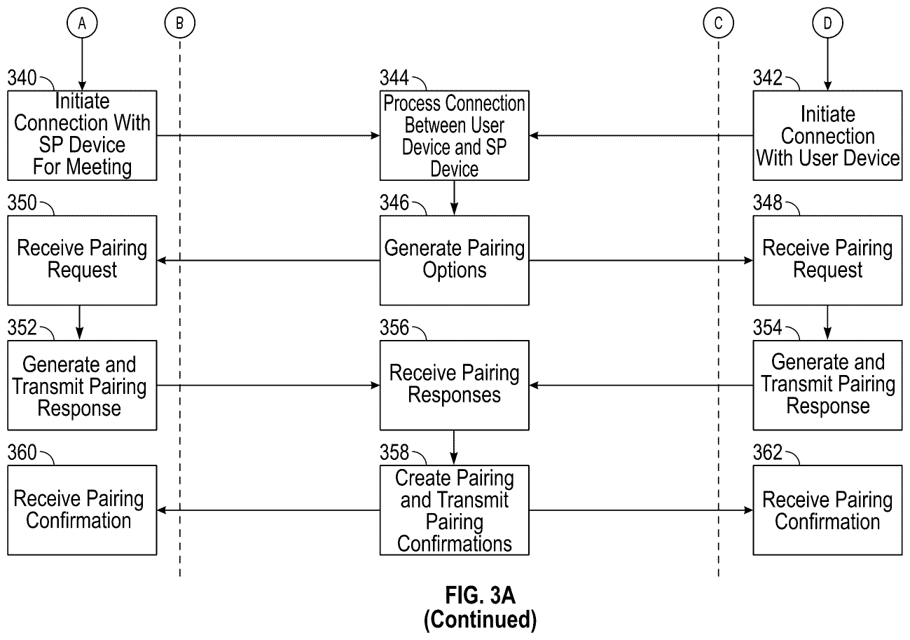

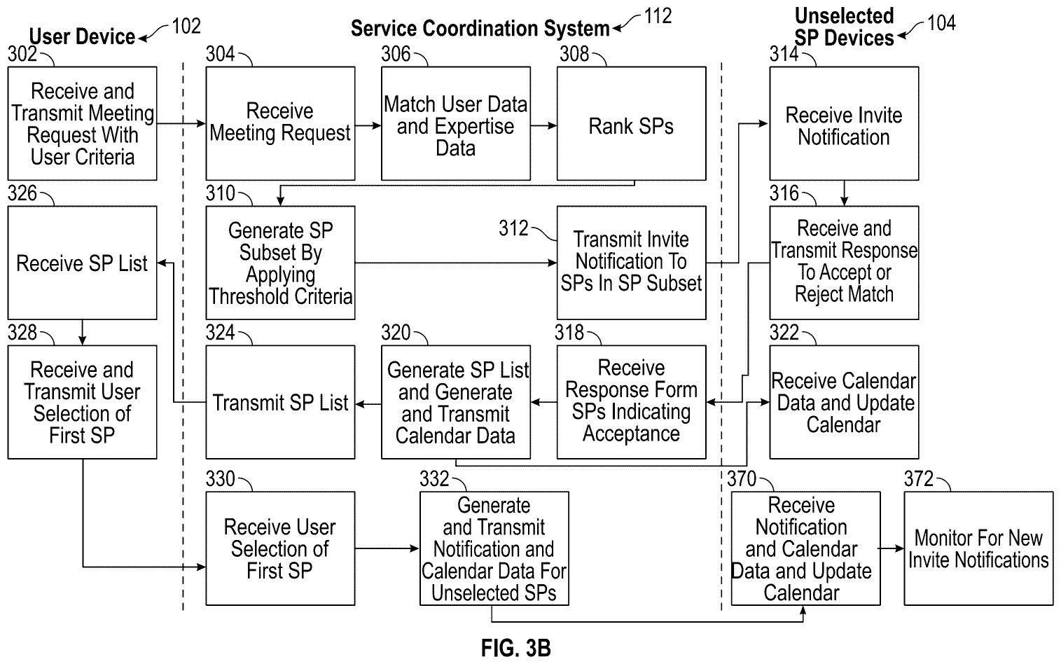

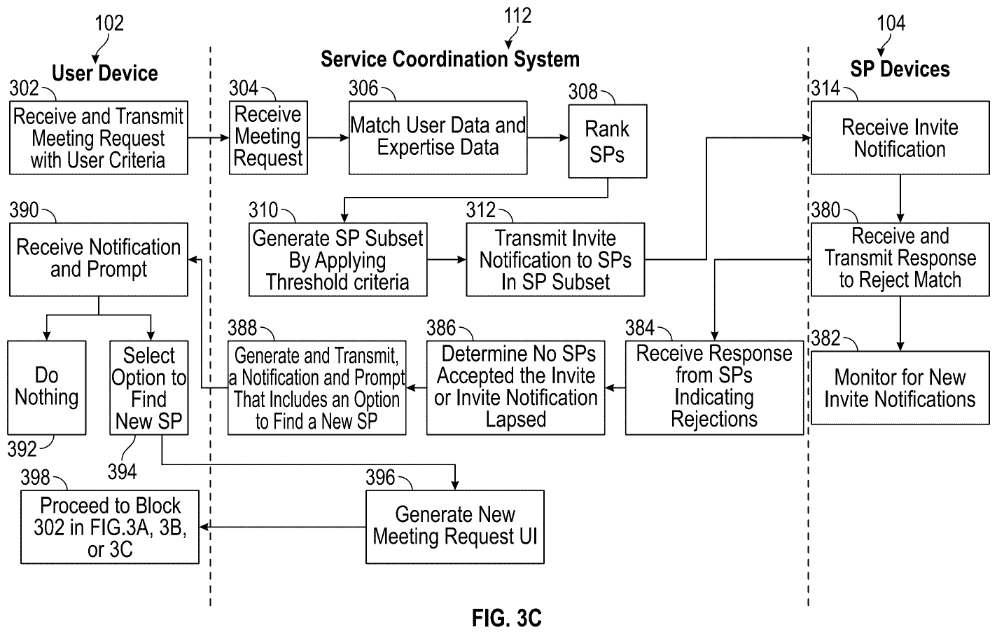

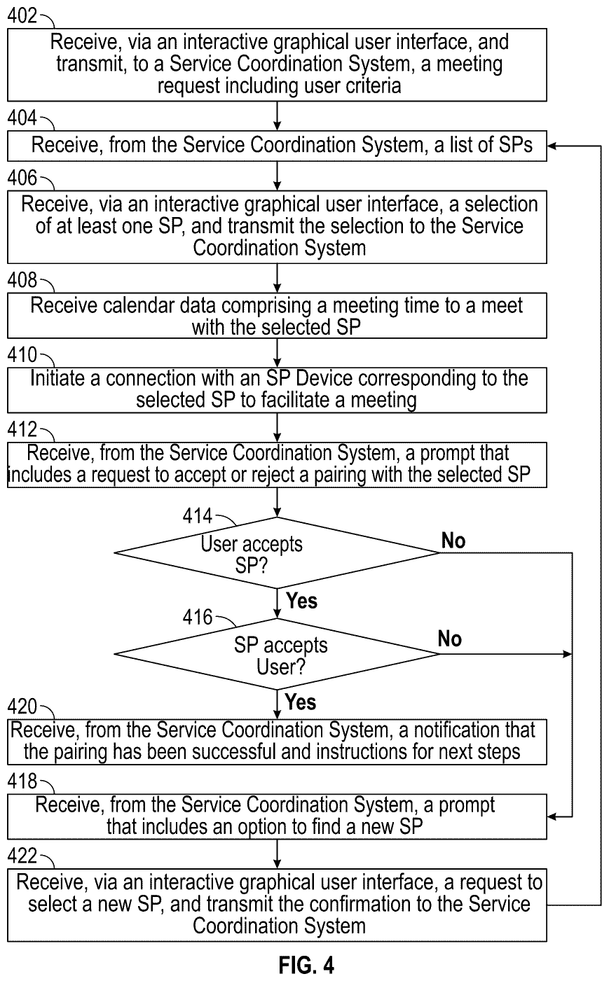

In some embodiments, the user device(s) 102 may be a personal computer, a laptop computer, a smart phone, a tablet, smart watch, and/or the like, which can be used by a user to access a service coordination system 112 over network 101. A user may access service coordination system 112 to find a service provider using the platform, to communicate with a service provider, view information related to their profile on the platform and/or the like. Use of the user device(s) 102 during a pairing/matching process is illustrated in FIGS. 3A-3C, and 4.

b) SP Device(s)

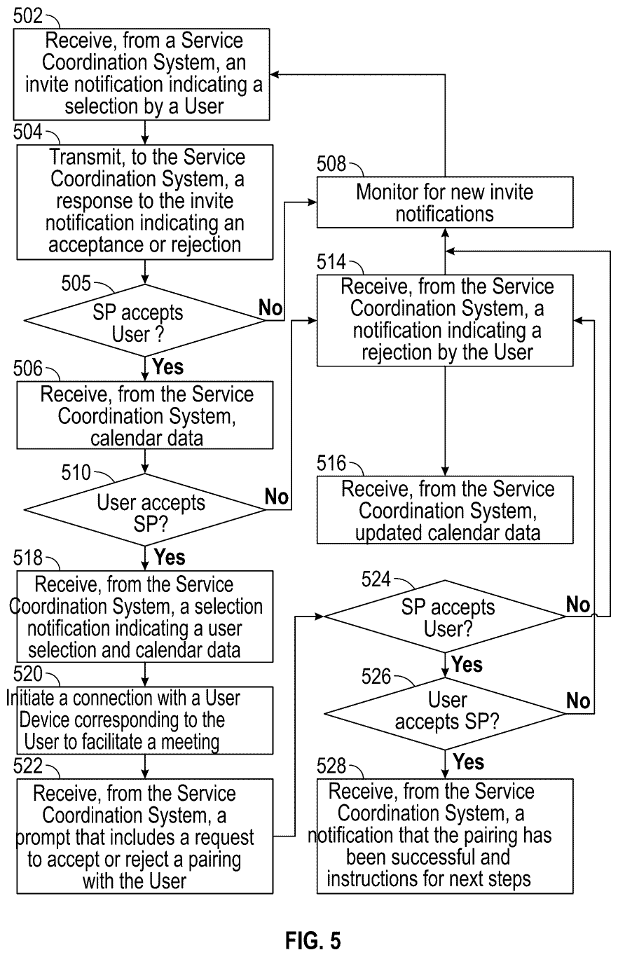

In some embodiments, the SP device(s) 104 may be a personal computer, a laptop computer, a smart phone, a tablet, smart watch, and/or the like, which can be used by a SP to access a service coordination system 112 over network 101. A SP may be any service provider whose industry or services are supported by the service coordination system 112. For example, a SP may be a financial advisor, contractor, IT specialist, fitness coach, accountant, tax advisor and/or the like. A SP may access service coordination system 112 to be matched with users looking for the SP's services, to communicate with users, to provide information and advice to paired users, and/or the like. Use of the SP device(s) 104 during a pairing/matching process is illustrated in FIGS. 3A-3C, and 5.

c) Third Party Device(s)

In some embodiments, the third party device(s) 106 may be a personal computer, a laptop computer, a smart phone, a tablet, smart watch, server, and/or the like, which can be used to communicate with service coordination system 112 over network 101. The service coordination system 112 may communicate with third party device(s) 106 through one or more data call services such as, for example, a batch processing system, an application programming interface (API) call (e.g., Calendly, Plaid, etc.) or other electronic communication channel. The service coordination system 112 may communicate with third party device 106 to access third party platform(s) 108 that are associated with a third party.

d) Third-Party Platform(s)

In some embodiment, one or more third-party platform(s) may be in communication with service coordination system 112 over network 101. The third-party platforms 108 may comprise one database or multiple databases. For example, there may be a separate database corresponding to each third-party or data from multiple third parties may be stored using virtual partitions or access privileges to prevent the sharing of data among third parties. The third-party platforms 108 may be controlled by a database management system. The third-party platforms 108 may be configured to store investment/allocation data associated with allocation component 220 and/or other elements associated with the service coordination system 112 as describe further herein. In some embodiments, the service coordination system 112 may communicate directly with third-party platforms 108 over network 101. The service coordination system 112 may communicate with third-party platforms 108 through one or more data call services such as, for example, a batch processing system, an API call (e.g., Calendly, Plaid, etc.) or other electronic communication channel. A third party may be any third party with information that can be utilized by the service coordination system 112. In some embodiments, a third party may have information which may be stored in third party data store(s) 110, such as information regarding stocks, exchange traded funds (ETFs), mutual funds, crypto currency, bonds, fixed-income securities, cash equivalents, and/or the like, such as, for example, current price, historical price information, current daily trade volume, average trade volume, market cap, price-earnings ratio, dividend yield ratio, holdings, number of holdings, inception date, expense ratios, assets under management, average returns for various time periods, net asset value, load fees, purchase fees, 12b-1 fees, ex-dividend dates, report dates, end dates, bond terms, face value, coupon rate, coupon date, issue price, and/or the like. A third party may include, for example, one or more stock exchanges, such as, for example New York Stock Exchange, Nasdaq, Shanghai Stock Exchange, Euronext, Japan Exchange Group, Hong Kong Stock Exchange, Shenzhen Stock Exchange, London Stock Exchange, Bombay Stock Exchange, National Stock Exchange, Toronto Stock Exchange, and/or the like. In another example, a third party may be other platforms and/or entities with information such as brokerages, banks, cryptocurrency platforms, governments, government treasuries, corporations, agencies, and/or the like.

e) Third Party Data Store(s)

In some embodiments, the third-party platforms 108 may include, one or more third party data store(s) 110. The third party data store(s) 110 may be configured to store data associated with one or more third-party platforms 108. For example, as described above, third party data store(s) 110 may store data related to investments/capital allocation that can be accessed using, for example, the allocation component 220.

f) Service Coordination System

In some embodiments, a service coordination system 112 may communicate with one or more devices (for example, user device 102, SP device 104, or the like) over network 101 to facilitate the matching and pairing of users and SPs. The service coordination system 112 is described further herein with reference to FIG. 2. Use of a service coordination system 112 to facilitate a matching/pairing process of a user and SP is illustrates in FIG. 3A-6B.

g) Network(s)

In some embodiments, the network 101 may comprise one or more networks, including, for example, a local area network (LAN), wide area network (WAN), and/or the Internet, for example, via a wired, wireless, or combination of wired and wireless, communication links. The network 101 can facilitate communication between the devices 102, 104, 106, third-party platforms 108, and the service coordination system 112.

While FIG. 1 shows an example number of systems in communication with network 101, it is recognized that in some embodiments, multiple user devices 102, SP devices 104, third party devices 106, third-party platforms 108 may be in communication with network 101 and the service coordination system 112. Further, “multiple” can include, for example, tens, hundreds, thousands, or millions, of systems in communication with the service coordination system 112. The devices in communication with service coordination system 112 (for example, user devices 102, SP devices 104, third party devices 106) can each include one or more databases and/or parameters. The databases can include data associated with communications conducted by a user, SP, or third party. It is recognized that the database may be stored in whole or in part on site in a facility or in one or more cloud storage locations.

### B. Service Coordination System

FIG. 2 illustrates an embodiment of the service coordination system 112 and platform subcomponents. Service coordination system 112 may include one or more of the following subcomponents: communications component 114, pairing engine 118, scheduling component 216, visualization component 218, allocation component 220, chatting and logging component 222, video conferencing component 224. Service coordination system 112 may include one or more of each subcomponent for each service offered by the platform. For example, there may be a pairing engine 118 that is utilized for financial advisor matching or pairing.

In some embodiments, the service coordination system may include one or more additional service components. For example, there may be one or more service components related to additional services offered, such as, for example, mortgage services, insurance services, financial planning services, financial advisory services, and/or the like.

It is recognized that there are other embodiments of the service coordination system 112 which may exclude features of the example service coordination system 112 and/or may include additional features. As such, some of the processes and/or modules discussed herein may be combined, separated into sub-parts, and/or rearranged to run in a different order and/or in parallel. In addition, in some embodiments, different blocks may execute on various components of the service coordination system 112.

a) Communications Component

In some embodiments, the communications component 114 may be configured to facilitate communication between the service coordination system 112 and other systems and devices. For example, the communications component 114 may facilitate communication with user devices 102, SP devices 104, third party devices 106, and/or third-party platforms 108. In some embodiments, the communications component 114 may include one or more data input components and one or more data output components. The one or more data input components may be configured to receive and process various input data into the service coordination system 112. The one or more data output components may be configured to process and format various data and results of the various analyses for access by other systems, such as the user devices 102, SP devices 104, third party devices 106, and/or third-party platforms 108. The communication component 114 may generate and transmit one or more of the notifications described herein (for example, invite notifications, pairing notifications, or the like). Notifications transmitted by the communications component 114 may include emails, text messages, phone calls, platform notifications, and/or the like and may be variable for different embodiments of the service coordination system 112 and for different types of notifications. Users and SPs may also be able to modify the types of notifications they receive.

b) Data Store(s)

In some embodiments, service coordination system 112 may include a data component or individual data stores that may be configured to control and manage the storage of data within the service coordination system 112. For example, data stores may respond to requests from various systems for accessing or updating the data stored within the service coordination system 112. The one or more data stores of the service coordination system 112 may include for example, general data store 202, account data store 204, SP data store 206, schedule data store 208, and/or the like. The data stores 202, 204, 206, 208 may comprise one data store or multiple data stores. For example, there may be a separate database corresponding to each user or each SP or data from multiple users or SPs may be stored using virtual partitions or access privileges to prevent the sharing of data among users and SPs. The service coordination system may include a database management system.

a) General Data Store

In some embodiments, the general data store 202 may be used to store data related to the service coordination system 112. For example, the general data store 202 may store data related to system processes, machine learning algorithms, or the like. In some embodiments, data associated with the chatting and logging component 222 (for example, chat data and file sharing system data) may also store files in the general data store 202.

b) Account Data Store

In some embodiments, the account data store 204 may be used to store data associated with users of the service coordination system 112. For example, the account data store 204 may store user profile data, user information, user documents uploaded from the user UI, expertise criteria, user preferred qualification, or the like.

c) SP Data Store

In some embodiments, the SP data store 206 may be used to store data associated with the SP who use the service coordination system 112. For example, the SP data store 206 may store SP profile data, SP information, SP documents, uploaded from the SP UI, expertise data, SP criteria, SP registration documents and agreements, or the like.

d) Schedule Data Store

In some embodiments, the schedule data store 208 may be used to store schedule data associate with users, SPs, and the service coordination system 112. For example, the schedule data store 208 may store calendar data associate with both users and SPs, notification data, or the like.

c) Pairing Engine

In some embodiments, pairing engine 118 may be configured to match users with SPs to facilitate a pairing of a user with a SP. Pairing engine 118 may include one or more subcomponents, such as, for example, ranking component 210, machine learning component 212, pairing component 214, and/or the like. In some embodiments, pairing engine 118 may include more or less subcomponents and in some embodiments, one subcomponent may perform the role of one or more other subcomponents.

In some embodiments, the pairing engine 118 facilitates a matching and pairing process that includes a computer system providing a user with a user interface (“UI”) (for example, via user device 102) that include functionality to enable the user to search for one or more SPs, generate meeting requests to pair and match with one or more SPs, and generally interact with one or more SPs. One example purpose of the matching/pairing process is to find SPs who offer services that a user is interested in, and eventually facilitate a formal relationships or arrangement. As described further herein, in some embodiments, to begin the matching/pairing process, users complete meeting requests generated by the computer system and presented on the user UI that may include user selectable/fillable data fields that relate to desired attributes and services to be provided by a SP. Similarly, SPs may also indicate or include preferences (for example, SP criteria) by inputting criteria into the system (for example, while creating a profile) that indicates one or more requirements or preferences for matching/pairing with users. Based on a user meeting request (as well as potentially other relevant user data) and SP criteria (as well as potentially other relevant SP data), the pairing engine 118 can search and identify a set of SPs that can perform any services indicated in the user meeting request, for example, and based at least in part on any data provided by or on behalf of the user and/or the SPs. In some embodiments, based on any search criteria (for example, as provided in the user meeting request), the pairing engine 118 identifies a set of SPs whose profiles include at least one or more of any data included in the user meeting request. In some embodiments, the pairing engine 118 (for example, using a machine learning component 212) calculates a base score for each of the data fields for each SP included in the set, the base score providing an indication of similarity between any data values included in the user meeting request and/or any corresponding data from SP profiles (for example, associated with some or all SPs in the system). In some embodiments, the base score(s) are adjusted by normalizing the scores and/or applying weights to the based scores based on the user or system indicated relative importance of the data fields. The adjusted or weighted base scores can then be used by the pairing engine 118 to calculate a matching score for each SP, where the matching score may indicate the likely compatibility between the user and the SP. In some embodiments, SPs with a determined match score above a threshold value receive invite notifications from the service coordination system 112 that indicates that the SP may be matched with a user and can potentially be paired. Generally, and in some embodiments, SPs who accept the invite, sometimes within a certain time period (for example, 10 minutes, 30 minutes, 1 hour, 12 hours, 24 hours, 48 hours, 1 week, or the like, as well as being the first 1, 2, 5, or the like SPs to accept the invite out of a group of SPs that receive an invite), are included on a list of SPs that is presented to the user for selection by the service coordination system 112. The matching and pairing process is described further herein and with reference to FIGS. 3A to 6B.

As described further herein, once a user and SP agree to be paired with each other, for example, by accepting the pairing request generated by the service coordination system 112, the parties can proceed with a formal relationship. In some cases, depending on the type of SP and the services provided, certain legal agreements may need to be reviewed and signed by one or both parties. The service coordination system 112 may generate these legal agreements or may allow the SP to transmit the legal agreements to the user for the user to sign. Legal agreements may be stored in the service coordination system 112 for compliance purposes. In some embodiments, the legal agreements may be presented to the user or SP during the account opening and profile creation stage.

As the relationship progresses, users may be able to rate the SP with whom they are paired with. A rating may include a numerical rating (for example, 1-5), a letter grade rating (for example, F-A), a selection of a number of stars, and/or the like. The rating may be used the service coordination system 112 during the ranking of SPs in a matching/pairing process and may be viewable by other users to help with their selection of a SP. Once a SP has received a certain number of ratings, such as, for example, 1, 2, 3, 4, 5, 10, 15, 20, and/or the like, an overall rating may be generated by the service coordination system 112 and the overall rating may be displayed on the SP's profile that is viewable by a user prior to or during the matching/pairing process. In some embodiments, individual ratings may only impact a user's overall rating for a certain amount of time. For example, an individual rating may only be part of a user's overall rating for 1 month, 2 months, 3 months, 6 months, 9 months, 12 months, 2 years, 5 years, and/or the like. By only recent ratings in a SP's overall rating, a SP can overcome bad ratings by improving their performance and may not be impacted by bad ratings from years ago. Similarly, in some embodiments, user's may be able to leave reviews or comments on a SP's profile after pairing. These comment/reviews can help other users in their selection of a SP.

a) Ranking Component

In some embodiments, ranking component 210 may be configured to rank and/or generate a subset of SPs based in part on criteria provided by a user as described further herein. In some embodiments, the ranking component 210 may access SP information stored in, for example SP data store 206, to compare to the user criteria stored in, for example account data store 204, to rank a subset of SPs for a particular user. SP information may include, for example, geographic location, expertise data, years of experience, licenses, certifications, rating, fiduciary/non-fiduciary designation, background, education, and/or the like to compare to the user criteria. Ranking component 210 may also be configured to match a user to a subset of SPs based in part on the user criteria and the SP information. For example, as described further herein, a user may provide a list of expertise criteria that the user wants a SP to have. Ranking component 210 may compare the expertise criteria to the SP expertise data to generate a subset of SPs who, based on their information, meet the requirements of the expertise criteria provided by the user. In some embodiments, the matching may be performed by a separate subcomponent of pairing engine 118.

b) Pairing Component

In some embodiments, pairing component 214 may be configured to facilitate a pairing or assignment between a user and a SP after both parties agree to be paired. In some embodiments, pairing component 214 may provide a shared platform and/or UI that both a user and a SP who are paired can access to communicate, share files, schedule meetings, monitor investments, and/or the like.

1. Relationship Termination

In a typical embodiment, once a user has been paired with a SP, the pairing must be terminated before the user can generate a new meeting request (for the same type of SP) and match/pair with a new SP. Depending on the type of services provided by a SP, the termination procedures may differ. Some pairings are intended to be long-term relationships and may require formal legal agreements, while other pairings are intended to be short term relationships without formal legal agreements. For example, a user may be able to terminate a pairing with a fitness coach more easily than a user could terminate a relationship with a financial advisor. In some embodiments, the service coordination system 112 may include one or more safety features to prevent unintentional or rash termination decisions. For example, the service coordination system 112 may require that a user sign an agreement agreeing to end the relationship prior to a termination being accepted. Either the SP or the user can terminate the pairing. For some types of SPs, more formal termination requirements and procedures may be implemented. For example, some types of SPs may be required to give advance notice of an intention to terminate the relationship with a user. In some embodiments, where SPs are required to provide advance termination notice, users may be able to submit new meeting requests and match with new SPs in order to find a replacement SP before the relationship with the original SP is terminated. This process can allow for the seamless transition from one SP to the next. Once a relationship/pairing is terminated, the user's UI may revert to the original color scheme and the meeting request function may become active again.

c) Machine Learning Component

In some embodiments, machine learning component 212 may be used to improve different aspects of the processes implemented by the service coordination system 112. For example, the machine learning component 212 may update different elements of the matching/pairing process described herein. The machine learning component 212 may include one or more machine learning systems/models, such as, for example, machine learning, artificial intelligence, neural networks, decision trees, and/or the like. For example, the machine learning component 212 can implement machine learning (“ML”) algorithms or artificial intelligence (“AI”) algorithms that may, for example, implement models that are executed by one or more processors. Having an AI/ML model to match or pair can provide significant improvements as compared to conventional systems because weighting different factors/inputs may vary in unpredictable or surprising ways that the AI/ML model can be customized and trained to determine. In some embodiments, the machine learning component 212 can use one or more machine learning algorithms to implement one or more models or parameter functions for the detections/identifications.

In some embodiments, a machine learning model can receive inputs it uses to train and/or apply the machine learning model to generate an output. In some embodiments, for example, and with respect to a particular user, inputs can include any and/or all user-provided or related information and data (for example, interests, employment or employer information, demographic information, residency, interests, personal and financial preferences, net worth, third party account data or access to third party accounts, marital information, age, sex, gender, or anything else provided by the user). In some embodiments, the user's online presence (for example, social media and/or public records) or browsing habits may be used as inputs as well. In some embodiments, for example, and with respect to a one or more service providers, inputs can include any and/or all service provider-provided or related information and data (for example, interests, employment or employer information, demographic information, residency, interests, personal and financial preferences, net worth, third party account data or access to third party accounts, marital information, age, sex, gender, or anything else provided by the service providers). In some embodiments, the service providers' online presence (for example, social media and/or public records) or browsing habits may be used as inputs as well. In some embodiments, the service providers' work performance (for example, investment success, certifications and licenses, access to various additional products or services, tenure, resume, employment information) can be used as inputs as well. With respect to outputs from the machine learning model, for example, the machine learning model may output a determined list of ranked or recommended service providers to as compared to a particular user based on weighted inputs, where the weights are determined by the machine learning model during training.

In some embodiments, the machine learning model can be trained based on annotated data comprising electronic information pertaining to successful and/or unsuccessful pairings. For example, a successful pairing may be a user who has paired with a specific servicer provide and has been paired for multiple years. Also, for example, a successful pairing may be a user who has paired with a specific service provide such as a financial advisor and has invested a large amount of money and/or a large amount of the user's net worth with the financial advisor. Also, for example, an unsuccessful pairing may be a user and/or service provider who has rejected a pairing (for example, at the initial recommendation step(s), based on an initial meeting, or after being paired for days, weeks, months, or years).

In some embodiments, a machine learning model can be further trained based on annotated data comprising electronic information pertaining to a magnitude of success or lack of success. For example, a length of time a user and service provider are paired can be a factor used by the machine learning model during training or application of the model. For example, a user and/or service provider may reject a pairing at some point (for example, at the initial recommendation step(s), based on an initial meeting, or after working together for days, weeks, months, or years) and the length of time may be a factor used by the machine learning model or machine learning component 212. Another factor related to magnitude of success or lack of success, for example, can be an amount of money invested (for example, with a financial advisor). For example, the machine learning model or machine learning component 212 can use data related to a user who has paired with a specific service provide (for example, such as a financial advisor) and has contributed a large amount of money and/or a large amount of the user's net worth with the financial advisor.

In some embodiments, the trained machine learning model can then be applied, by the service coordination system 112, to new meeting or pairing requests, or currently paired individuals, as part of a pairing engine (for example, 118) to determine, generate, and rank new potential matches to recommend.

In some embodiments, the service coordination system 112 (for example, by the pairing engine 118) can receive SP data and preferences (for example, SP expertise criteria, SP criteria, or the like), user data and preferences (for example, user questionnaire, user input preferred qualifications, user criteria, or the like) and meeting requests or user meeting requests as described herein, and use this information to determine matching scores for one or more SPs during the matching/pairing process (for example, matching and ranking). In some embodiments, generation of a matching score may be based at least in part on a machine learning model or algorithm. Based on a matching threshold value, the SPs with a matching score above the matching threshold may be presented to the user for selection, depending on the threshold criteria included in the original meeting request, for example. In some embodiments, the matching scores can be based on various base scores that are calculated (for example, by the machine learning component 212) based on a comparison of individual attributes associated with a user (including the meeting request) and corresponding attributes associated with a SP (and the related SP business as applicable), which may then be normalized and/or otherwise adjusted, such as to assign respective weights to data fields based on the likely (or indicated) importance to the user.

For example, in some embodiments, the service coordination system 112 may compare the user generated meeting request (for example, for a financial advisor with technology experience) to services offered by an SP (for example, financial advice related to clean energy), to calculate a base score for that comparison. Additionally, further base scores can be calculated for each criterion included in the meeting request (for example, preferred qualifications related to SP location, years of experience, or the like, and described further herein). All the base scores can then be normalized or otherwise adjusted and combined by the pairing engine 118 to calculate a matching score for each SP. In some embodiments, users may be able to indicate in the meeting request, the relative importance of each element included (for example, year of experience is valued higher than geographic location). In some embodiments, the meeting request may have pre-set relative importance, such as, for example, highest importance for the expertise criteria included and lower importance for the preferred qualifications. Based on these weightings, the pairing engine 118 may then adjust one or more base scores for certain fields in the meeting request up or down by applying one or more weights that correspond to the user indicated relative importance of each field (or system indicated relative importance). Matching scores can then be compared to the matching threshold value to determine which SPs to transmit invite notifications to and/or include in a list of SPs presented to the user in response to a meeting request. In some embodiments, as described further herein, the matching threshold or value may be adjusted one or more times by the system to ensure that a certain number of SPs are included in a first set to receive invite notifications and/or to provide to the user (e.g., in a list). In some embodiments, the matching threshold values are adjusted by the pairing engine 118 based on the type of services requested in the meeting request. For example, there may be a lower matching threshold value for services that do not include a large number of SPs (for example, a niche services) and a higher matching threshold value for services that include a large number of SPs (for example, general services). Matching and ranking processes are described further with reference to FIG. 3A.

A number of different types of algorithms may be used by the machine learning component to generate the models. For example, certain embodiments herein may use a logistical regression model, decision trees, random forests, convolutional neural networks, deep networks, or others. However, other models are possible, such as a linear regression model, a discrete choice model, or a generalized linear model. The machine learning algorithms can be configured to adaptively develop and update the models over time based on new input received by the machine learning component. For example, the models can be regenerated on a periodic basis as new received data is available to help keep the predictions in the model more accurate as the data is collected over time. Also, for example, the models can be regenerated based on configurations received from a user, admin, or other devices. Some non-limiting examples of machine learning algorithms that can be used to generate and update the models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithm. These machine learning algorithms may include any type of machine learning algorithm including hierarchical clustering algorithms and cluster analysis algorithms, such as a k-means algorithm. In some cases, the performing of the machine learning algorithms may include the use of an artificial neural network. By using machine-learning techniques, large amounts (such as terabytes or petabytes) of received data may be analyzed to generate models without manual analysis or review by one or more people.

d) Scheduling Component

In some embodiments, scheduling component 216 may be configured to facilitate the scheduling of user meetings with SPs and host digital meetings, such as video conference meetings, between a user and a SP. In some embodiments, scheduling component 216 may generate alerts, notifications, or calendar data to transmit to user devices 102 and/or SP devices 104. In some embodiments, the scheduling component may access data stored in the schedule data store 208, such as, for example, calendar data related to the users and/or SPs.

e) Visualization Component

In some embodiments, visualization component 218 may be configured to generate user interfaces and display graphics for user devices 102 and SP devices 104. For example, the visualization component 218 may be used to generate investment related graphics for the user and SP user interfaces (UIs).

Once a user has created their profile and logged on to the service coordination system 112, they may access a user UI associate with their profile. The UI may include numerous sections and tools to facilitate the processes and services provided by the service coordination system 112 described herein. While some UI features will be described herein, those skilled in the art will recognize that many other well-known UI features can also be included in the service coordination system 112. UI features and displays may be generated and presented on user device 102 using, for example, visualization component 218.

Prior to being paired with a SP, the user UI may include a user selectable meeting request button. When a user clicks the button, the service coordination system 112 may generate a new UI or modify the existing UI to present the user with a user selectable and fillable meeting request page. Once the user has transmitted (completed) the meeting request, the user UI may be modified to indicate that a meeting request is pending. Once a meeting is set by the service coordination system 112, the calendar data received by the user device 102 (for example, at block 334 of FIG. 3A) may be configured to update the user UI. For example, where the meeting request button was previously, there may now be an indication of the scheduled meeting time. The user may also click the scheduled meeting time button to join the video conference as described herein.

The user UI may also include a calendar portion that indicates when scheduled meetings are. While a user may typically only have one user-SP meeting scheduled at a time, once the user has paired with a SP, the calendar may include future meeting scheduled with the paired SP. The calendar may also be configured to sync with other calendars associated with the user on the user device 102, so that the user can plan around other calendar events not related to the services provided by the SP. In some embodiments, the calendars may be generated by the scheduling component 216.

Once a user pairs with a SP, the user UI may be modified to update the display to match the UI of the paired SP in part. For example, the background and primary/accent colors of the user UI may be updated to match the colors of the paired SP and a logo associated with the paired SP may be displayed on the user UI. The meeting request button may also not be displayed. Instead, the next scheduled meeting with the paired SP may be displayed on the user UI.

Depending on the type of SP the user is paired with, different features may be included on the user UI. For example, in the case of a financial advisor SP, the UI may display investment information associated with the user as described herein with reference to the allocation component. A section of the user UI may also include access to further information related to the type of service the user is looking for. For example, continuing with the financial advisor example, the UI may display investment related information, user selectable links to third-party investment related articles or resources, and/or the like.

The user UI may include a section where users can research SPs. For example, a user may be able to input search criteria (for example, expertise criteria) and the service coordination system 112 may modify a portion of the UI or generate a new UI to displace the profiles of different SPs. The user may be able to filter the profiles further based on geographic location, immediate availability, rating, and/or the like.

In some embodiments, the user UI may include a section where the user can access a file sharing system, described further herein with reference to the chatting and logging component. For example, the user may be able to click on the file sharing section of the UI and the UI may be modified or a new UI may be generated that a user can use to access the files shared with the paired SP. When a user has not paired with a SP, the user UI may still include the file sharing system portion, which the user may use to save files they anticipate sharing with a future paired SP.

Similar to a user, once a SP has created the profile and logged on to the service coordination system 112, they may access a SP UI associated with their profile. The SP UI may include numerous sections and tools to facilitate the processes and services provided by the service coordination system 112 described herein. While some UI features will be described herein, those skilled in the art will recognize that many other well-known UI features can also be included in the service coordination system 112. UI features and displays may be generated and presented on user device 102 and SP devices 104 using, for example, visualization component 218.

As described herein, the SP UI may include one or more sections that display upcoming meetings with users. Like the user UI, the upcoming meetings can be used to access the related video conference at or around the scheduled meeting time. In some embodiments, the SP UI may display a certain number of the upcoming meetings (for example, the next five meetings), and the SP may access a full list of upcoming meeting by, for example, clicking a drop down menu that modifies the UI or by clicking a button to generate another UI that illustrates all upcoming meetings.

The SP UI may also include a calendar portion that indicates when scheduled meetings are. The calendar may include meetings related to the matching process as well as future meeting scheduled with the paired users. The calendar may also be configured to sync with other calendars associated with the SP on the SP device 104, so that the SP can plan around other calendar events not related to the services provided by the SP. Additionally, because SPs are typically third parties, they may have meetings scheduled related to their services that are not associated with the service coordination system 112. By syncing the calendars, the SP can see their entire upcoming schedule. The synced calendar can also be used by the service coordination system 112 (for example, scheduling component 216) during the matching/pairing process. For example, the service coordination system 112 can identify time blocks in the SP's schedule and not transmit invite notifications to SPs with conflicting events in their schedule, even if the conflicting events are unrelated to the service coordination system 112. In some embodiments, a SP may be able to select which events in their schedule generate a time block. For example, a SP may be able to add an event to their calendar that is optional and remove any time block associated with the event so they can still receive invite notifications that conflict with that event. This feature allows the SP to have a full view of their entire schedule without concern that events added may prevent them from meeting new users.

The SP may be able to select the color scheme (primary colors and accent colors) to identify with their unique brand. The SP may also be able to upload logos associated with their brand to display on the SP UI. As described herein, the color and logo may be used to update the user UI once and pairing has been completed.

The SP UI may include a portion that displays the current list of users the SP has paired with. In some embodiments, the SP may be able to click a name of a user and the service coordination system 112 may generate a new UI associated with the specific user or may modify the UI of the SP to display information about the user. For example, a SP may be able to access and display investment data associated with the user in the example where the SP is a financial advisor. The SP may also be able to access the file sharing system associate with each user to retrieve files added by the user or to add files they want the specific user to be able to access. The SP UI may include a section that displays the current rating of the SP and may include access to comments left by users the SP had paired with. The SP can use this information improve their performance as a SP.

Related to the matching process, in some embodiments, the SP UI may include a feature to toggle on and off their matching capabilities. When the SP turns the matching toggle off, they won't receive any invite notifications from the service coordination system 112. A SP may use this feature when they are at capacity for paired users or don't want to be matched with any new users (for example, on vacation). The SP UI may also include SP selectable times when they are unavailable to meet. The service coordination system 112 will use these selectable times to prevent the SP from receiving invite notifications that conflict with those times. For example, a SP may not want to meet with users from 9 PM to 9 AM. When a SP selects certain times, the calendar may also be updated to indicate that there can be no meetings scheduled for those times. For example, those specific times may appear as a different color on the calendar, or the typical calendar view may exclude those times.

Both the user UI and the SP UI may include a settings portion that can be selected by, for example clicking the settings button. The user and SP may use this portion to manage the current settings. Modifiable settings can include, for example, changing the password, profile data (for example, email, phone number, address, and/or the like), deleting the account, adjusting the type of notifications received (for example, turning on or off email or text notifications), and/or the like.

f) Allocation Component

In some embodiments, allocation component 220 may be configured to provide investment data for the service coordination system 112. In some embodiments, allocation component 220 may communicate with third party devices 106 and/or third-party platforms 108 to access and/or receive data related to investments as described herein. In some embodiments, the investment information may be used to update UIs associated with service coordination system 112, such as by, for example, visualization component 218.

In an embodiment where SPs are financial advisors and/or other SPs who provide investment related advice, the SPs may need access to investment data related to the users they are paired with. The service coordination system 112 (for example, allocation component 220) may be able to gather investment data related to individual user's account in order to determine a user's investment holdings and information related to the investments. The allocation component 220 may communicate with third party devices 106 and third-party platforms 108 to gather the investment data using one or more data call services (for example, APIs), batch processing transactions, and/or the like. Third-party platforms 108 can include entities that have user specific investment information such as, for example banks, brokerages, third-party investment platforms, third-party cryptocurrency platforms, government treasuries and/or the like as well as entities that have general investment information such as, for example stock exchanges, government treasuries, cryptocurrency platforms, and/or the like. Third-party platforms 108 may have information which may be stored in third party data store(s) 110, such as information regarding stocks, exchange traded funds (ETFs), mutual funds, crypto currency, bonds, fixed-income securities, cash equivalents, and/or the like, such as, for example, current price, historical price information, current daily trade volume, average trade volume, market cap, price-earnings ratio, dividend yield ratio, holdings, number of holdings, inception date, expense ratios, assets under management, average returns for various time periods, net asset value, load fees, purchase fees, 12b-1 fees, ex-dividend dates, report dates, end dates, bond terms, face value, coupon rate, coupon date, issue price, and/or the like. The service coordination system 112 can use this information to present the investment data related to users and their paired SPs. Because some information must be up-to-date (for example, stock prices), the service coordination system 112 may continuously update this information in real time and may process millions and billions of data files every minute.

In some embodiments, the allocation component 220 may include an Optical Character Recognition (OCR) system. The OCR system may be used in gathering investment related information from the third-party platforms 108. The OCR system may also be used by the allocation component 220 to convert text-based images in user documents into machine-encoded text. The user documents may be provided by third-party platforms 108 or the users themselves. For example, a user may upload an image-based document about their current investment, mortgage terms, and/or the like, and the OCR system may convert the text-based images to machine-encoded text for further use in the service coordination system 112.

Related to the UI features described herein, the investment information of a user may be presented in one or more different forms in the user UI (and may be visible from the paired SP's UI) such that a user can easily identify their current holdings, portfolio performance, portfolio diversity, different information related to their holdings (for example, current stock price), and/or the like. For example, a user's portfolio diversity may be displayed as a chart (for example, a pie chart) to display the different investment allocations such as, for example, stocks, bonds, ETFS, mutual funds, crypto currency, fixed-income securities, cash equivalents. The UI may also include one or more charts illustrating a user's allocations within a specific type of investment. For example, a chart may be used to illustrate which stocks a user currently is holding as well as sector allocation (for example, financials, utilities, consumer discretionary, consumer staples, energy, healthcare, industrials, technology, telecom, materials, real estate, and/or the like). Users may also be able to view their portfolio performance over time and may be able to change timeframe of the display. For example, a user may be able to view a graph/chart (for example, a line graph) that illustrates their performance over a certain time period (1 day, 1 week, 1 month, 3 months, 1 year, 5 years, all time) and the user can select which time period is currently being displayed. Users may also be able to view information related to individual investments such as, for example current price, historical price information, current daily trade volume, average trade volume, market cap, price-earnings ratio, dividend yield ratio, holdings, number of holdings, inception date, expense ratios, assets under management, average returns for various time periods, net asset value, load fees, purchase fees, 12b-1 fees, ex-dividend dates, report dates, end dates, bond terms, face value, coupon rate, coupon date, issue price, and/or the like. Even if a user is not currently holding a specific investment (for example, a specific stock) they may still be able to use the allocation component of the user UI to research investment information such as, for example, look up different stocks, bonds, cryptocurrencies and/or the like and find performance related information as described herein.

In some embodiments, users may be able identify certain goals related to their investments. Goals can include certain investment values for specific goals such as retirement, child education, property purchases, and/or the like. Goals can also include specific investment goals related to holding a certain value of investment in a specific or broad investment area. For example, a user may want their portfolio to be a 40% green related and the allocation component 220 may be configured to evaluate a user's investments and access whether they are meeting that goal. For example, the user UI may display a visual indication of how close the user is to meeting their goal such as a graphical display or may give a letter grade or percentage to target goal indication. Other goals can include a portfolio diversity goal, faith based investment goal, green goal, private vs public goal, growth vs value goal, specific industry goals, ESG goal and/or the like. Goals may be related to the expertise criteria selected when the user generated the meeting request. Goals may also be user adjustable. For example, a user may achieve a goal of having 50% faith-based investment portfolio and may wish to increase the target to 60%. The goals and associate ratings can help users quantify their investment portfolio in other terms rather than total value and help users determine which investments to keep and which investments to drop. Users may be able to set more than one goal and the user UI can display a rating for each associated goal. The allocation component 220 may also indicate which individual investments in a user's portfolio are related to a goal. For example, individual stock tickers may include symbols or some other visual indication if they fall within a certain category of investment, such as, for example, ESG or clean energy. Users may be able to set their own symbol related to a goal and the allocation component 220 may be able to identify which investments relate to the goal and modify the investment display to include the symbol.

In some embodiments, the service coordination system 112 may include tax information related to a user's investments. For example, the service coordination system 112 may be able to indicate potential tax implications from an investment disposition. The service coordination system 112 may also be able to generate tax forms related to a user's portfolio. The service coordination system 112 may be able to suggest certain tax control portfolios to help users mitigate potential tax issues through portfolio suggestions.

g) Chatting and Logging Component

In some embodiments, chatting and logging component 222 may be configured to facilitate instant messaging and file sharing between users and SPs. The chatting and logging component 222 may also be configured to create a system log of all text-based messages transmitted and files shared on the service coordination system 112 for auditory and compliances purposes.

a) Chat Room

The service coordination system 112 may include a chat room system that allows for instant messaging between users and matched/paired SPs using, for example, chatting and logging component 222. In some embodiments, the chat room may only be available during the user-SP video conference, while in some embodiments, the chat room may be available after and/or before the user-SP meeting. The chat rooms allows the user and SP to use their respective devices (102 and 104) to instant message each other using text-based communication. In some embodiments, the chat room may also include file sharing functionality where the parties can share files such as, for example, text files, image files (for example, joint photographic experts groups (JPEG), graphics interchange format (GIF), scalable vector graphics (SVG), portable networks graphic (PNG), and tagged image file format (TIFF)), document files (for example, portable document format (PDF), Word documents (DOC and DOCX), hypertext markup language (HTML and HTM), spreadsheets (XLS and XLSX), text files (TXT)), video files (for example, moving picture experts group layer four (MP4), audio video interleave (AVI), QuickTime movie file (MOV), flash video format (FLV), advanced video coding, high definition (AVCHD)), presentation files (for example, PowerPoint presentation (PPT or PPTX), open document presentation (ODP), Keynote file (KEY)), audio file (for example, MPEG 4 audio (M4A), MPEG 4 audio (M4A), MPEG 4 audio (M4A)), and/or the like. Instant messaging and file sharing capabilities may improve the way users and SPs communicate and can prevent off-platform methods of communication. The files shared can be files stored on the user device 102 and the SP device 104 and can also include files stored in a user or SP's account. For example, users and SP may be able to use the service coordination system 112 to store files they may want to share with another party and can use the chat room to transmit these files or the location of the files (for example, in a shared file system).

In some embodiments, some or all communications that occurs in the chat room (e.g., text-based communication, files shared, video, audio, and or the like) can be monitored and logged by the service coordination system 112 using, for example, chatting and logging component 222. For example, any information transmitted in the chat room may be written to an internal audit logging system of the service coordination system 112. The audit log may be downloaded by auditors to review the communication and files transmitted between users and SP. The logging system may log in-meeting communication as well as out-of-meeting communication. One purpose of the logging system is to prevent the chat room for being used for inappropriate behavior such as harassment or criminal communication. If a complaint is submitted by a user or a SP regarding another party's behavior, auditors can access the logging system to verify the complaints and take further action as required (for example, internal actions such as banning or suspending a parties' account and external actions including providing the audit log to the police). Another purposes of the logging system is for legal compliance with government rules and regulations. For example, where a service provider is a financial/investment advisor, certain government regulations may require that advisers make and keep certain books and records relating to their investment advisory business, including typical accounting and other business records. To ensure compliance with these rules and regulations, the service coordination system 112 maintains a log of all user and SP communications in case an external audit is required as part of an investigation. In some embodiments, the video conference may be recorded for similar purposes.

In some embodiments, where the chat room is available prior to the user-SP meeting, the chat room may be used by users and SPs who are matched to prepare for their meeting. For example, if one of the parties has a conflict arise, they may indicate to the other party using the chat room that they need to change the meeting time or that they will be late to the meeting. The chat room may also be used to request additional information from another party prior to the meeting. If the chat room is available following a meeting, the chat room may be used by a party to ask a follow-up question that wasn't addressed in the meeting, send a file the other party asked for, and/or the like.

In some embodiments, all files associated with the chat room (e.g., messages, files transmitted, and/or the like) may be stored in an encrypted format. For example, files may be stored in an encrypted format for the purpose of protecting any potentially sensitive information contained therein. In some embodiments, there may be data retention procedures related to files associated with the chat room. For example, data files may be identified and classified in order to determine which data retention procedures are applicable. Based on the classification, certain legal requirements related to data retention may be determined for each file type. In some embodiments, data files may be deleted once the files are no longer needed or after the data retention period has been met. For example, once the legal requirements regarding data retention have expired, the data files may be deleted.

b) Filing Sharing System

In some embodiments, once a pairing is created, both parties (for example, user and SP) may gain access to a file sharing system. In some embodiments, the file sharing system may be run by a third party, while in other embodiments, the file sharing system may be part of the service coordination system 112. The file sharing system may store files in, for example, account data store 204. The file sharing system may be used by the user and SP to easily upload files to the service coordination system 112 for the other party to review and download if required. In an example where the SP is an accountant, the file sharing may be used by the SP to upload a tax return prepared by the SP for the user so that the user can review the return and sign the return as required. Like the chat room, files shared in the file sharing system may be logged in the logging system using, for example chatting and logging component 222 for auditory and compliance purposes.

In some embodiments, all files associated with the file sharing system may be stored in an encrypted format. For example, files may be stored in an encrypted format for the purpose of protecting any potentially sensitive information contained therein. In some embodiments, there may be data retention procedures related to files associated with the file sharing system. For example, data files may be identified and classified in order to determine which data retention procedures are applicable. Based on the classification, certain legal requirements related to data retention may be determined for each file type. In some embodiments, data files may be deleted once the files are no longer needed or after the data retention period has been met. For example, once the legal requirements regarding data retention have expired, the data files may be deleted.

h) Video Conferencing Component

In some embodiments, video conferencing component 224 may be configured to facilitate digital communication, such as video calls/conferences, between parties such as users and SPs. As described further herein, and in some embodiments, part of the typical process of pairing a user with a SP involves the service coordination system 112 facilitating a meeting between the two parties. In some embodiments, and generally, the meeting is a video conference call between the user and SP because this type of meeting allows the parties to get to know each other, easily share documents, share their screens, and so forth, while still allowing a face-to-face meeting in safe environment. In some embodiments, the service coordination system 112 may support other types of meetings including, for example, email communication, chatting systems, phone calls, in person meetings, and/or the like. The type of meeting may vary based on the services provided by the SP. In some embodiments, the video conferencing may be provided by a third-party service, however, in a typical embodiment, the video conference is provided by the service coordination system 112, using, for example, video conferencing component 224.

Prior to the meeting start time, the UIs of the user and SP may display upcoming meetings. For example, the display of the user may indicate in an upcoming meeting section a 6:00 pm, April 30^{th} meeting with SP John Smith. The meeting time and SP name may have been updated based on the calendar data the user received from the service coordination system 112. The user's upcoming meeting section will typically only display one meeting because a user may only be able to have one scheduled meeting at a time. However, in some embodiments, a user may be able to schedule more than one meeting with different SPs, in which case, the upcoming meeting section may display more than one meeting. The UI of a SP may display more than one meeting in the upcoming meeting section and may be configured to list the meetings the SP has scheduled for the week, the next specific number of meetings the SP has scheduled, such as, for example, then next 1, 5, 10, 15, 20 meetings and/or the like. The number of meetings displayed in this section may be SP selectable. The upcoming meeting section may include the time and name of the user the SP is meeting with as well as some information about the meeting. For example, the upcoming meeting may include all or some of the user criteria included in the user's meeting request (for example, the expertise criteria) and may include some user provided information about what type of services the user is looking for. As described herein, the SP will not have any upcoming meetings with overlapping times because the service coordination system 112 prevents the SP from receiving invite notifications with conflicting times. In some embodiments, prior to the meeting start time, the upcoming meeting displayed on the UIs of both the user and the SP may be modified a certain amount of time prior to the meeting start time (for example, five minutes) to indicate to the parties that the meeting room is now accessible. The modification may include a text indication such as the words “live”, a color change (for example, changing all or part of the meeting display to green, blue, red, yellow, orange, and/or the like), or some other visual indication. In some embodiments, pop up notifications may be generated by the service coordination system 112 on the parties' UIs to indicate the meeting is scheduled to begin within a certain amount of time and/or alerts/notification may be transmitted by the service coordination system 112 to the user device 102 and SP device 104 to alert the parties that the meeting is about to start. Transmitted notifications may include email, SMS, and/or the like. The user and SP may be able to join the meeting room by clicking on the upcoming meeting which may cause the video conferencing component 224 to generate a video conference UI. In some embodiments, the parties may be able to join the meeting at any time during the scheduled meeting time by clicking the upcoming meeting. For example, if the meeting is scheduled between 6:00 PM and 6:30 PM, the user or SP may be able to join the meeting at any time during those 30 minutes. In some embodiments, if one or both parties do not join the meeting within a certain time, the meeting may be terminated by the service coordination system 112. If the meeting is terminated, the service coordination system 112 may transmit notifications to the user device 102 and the SP device 104.

Once both parties have joined the meeting, the parties can discuss the needs of the user and the services that SP can provide. The video conference generated by the service coordination system 112 may include one or more of the following: video display of the user and SP using cameras associate with the user device 102 and SP device 104, a selectable option to turn on and off the video display, a selectable option to turn on and off the microphone (for example, so a party can mute themselves while not talking), a selectable screen share option (for example, so parties can display their screens), adjustable volume control, a selectable option to give the other party control of a shared screen, and/or the like. It is recognized that while certain video conference functionality is described herein, the video conferencing features can include many other features.

In some embodiments, a user may be able to forgo the meeting process by selecting a pair instantly option when generating the meeting request. In this case, the system may send invite notifications to SPs who meet the user criteria, and the invite notification may indicate that the user is looking to pair instantly. However, in some embodiments, the parties meet to ensure they are compatible prior to a pairing. One of the purposes of requiring meetings prior to pairing is to facilitate user-SP relationships that will be long lasting.

### C. User and Service Provider Pairing Processes

FIGS. 3A-6B illustrate methods/processes of a user matching with, attempting to match with, and/or create a pairing with a SP using the service coordination system 112. In some embodiments, prior to a user beginning any of the methods illustrated in FIGS. 3A-6B, a user may be required to create a profile, such as by using user device 102 to connect to service coordination system 112. Information and data associated with a user's profile may be stored in account data store 204. The profile creation may require the user to input an email, create a username and password, and/or the like. In some embodiments, once a user has created a profile, the user may be prompted by service coordination system 112 to input further information such as, for example, by responding to a questionnaire. In some embodiments, a purpose of the question may be to determine and provide validity to the risk tolerance of a user. The questionnaire may comprise a series of questions with selectable answers and/or text input sections for a custom response. For example, the questionnaire may inquire about a user's investment experience, to which a user may be given the options of responding “no experience”, “some experience”, “experienced”, “very experienced”, and/or the like. The questionnaire may ask a user to input contact information, residence information, citizenship status, age, address, investment background, current investments, income, asset information, risk tolerance, return expectations, investment goals, held mortgages, refinancing plans, annual income, net worth, dependents, monthly expenses, previous tax information, and/or the like. The questionnaire may ask about a user's current investment holdings, The questionnaire may ask a user to write a short summary of what they are looking for in a service provider. In some embodiments, while completing the questionnaire, the user may be asked to select a series of expertise criteria related to the type of SP they would be interested in pairing with. For example, service coordination system 112 may contain a preset list of different expertise criteria for different types of SPs. For example, for a financial advisor, selectable expertise criteria may include retirement planning expertise, environmental, social, and governance (ESG) expertise, foreign investment expertise, technology investment expertise, oil and gas expertise, faith-based investment expertise and/or the like. In some embodiments, expertise criteria may include investment expertise that is specific to, for example, gender, age, specific stage of life, and/or the like. For example a user may be able to identify SPs who have experience working with women divorcees. In some embodiments, a user may be able to select one or more expertise criteria they are interested in such as, for example, by checking a box next to the criteria from a drop-down menu, dragging and dropping expertise badges onto their profile, and/or the like. In some embodiments, a user may only be able to select one expertise criteria when generating a meeting request. The expertise criteria selection will be discussed further herein.

In some embodiments, a user may be asked to input preferred qualification criteria that includes a user's preferences for SPs they may be matched with, such that the preferred qualification criteria can be used by the service coordination system 112 to better match a user with SPs. A user may be asked to input the preferred qualification criteria prior to scheduling a meeting or this information may be input while scheduling a meeting. The preferred qualification criteria may include anything related to a SP and generally corresponds to SP information provided by SPs, such as, for example, geographic location, years of experience, licenses, certifications, fiduciary/non-fiduciary designation, background, education, and/or the like.

Similar to the users, before a SP can utilize the service coordination system 112 and be considered as a potential match for a user, a SP must register with the service coordination system 112 and create a profile, such as, by using SP devices 104 to connect to service coordination system 112. Because most SPs are third parties, they may be required to sign legal agreements as part of the registration process. SPs must also generally be verified before their profile is “live” as described further below. Information and data associated with a SP's profile and information provided during registration may be stored in SP data store 206. The registration process may require the SP to input an email, create a username and password, and/or the like. Once a SP has created a profile, the SP may be prompted by service coordination system 112 to input further information such as, for example, by responding to a SP questionnaire. The SP questionnaire may comprise a series of questions with selectable answers and/or text input sections for a custom response. The SP questionnaire may ask a SP to input background information such as: contact information, residence information, citizenship status, address, and/or the like. The SP questionnaire may allow a SP to write a short biography/description where the SP can highlight their background, services, provided, expertise, and/or the like to customize their profile. The service coordination system 112 may contain a preset list of different expertise criteria that different types of SPs can add to their profile to increase the likelihood of matching/pairing with users, where the expertise criteria corresponds to the expertise criteria users can select when undergoing a matching process. For example, for a SP who is a financial advisor, selectable expertise criteria may include retirement planning expertise, environmental, social, and governance (ESG) expertise, foreign investment expertise, technology investment expertise, oil and gas expertise, faith-based investment expertise, and/or the like. Generally, SPs can select one or more expertise criteria they are qualified in such as, for example, by checking a box next to the criteria from a drop-down menu, dragging and dropping expertise badges onto their profile, and/or the like.

In some embodiments, SPs may be able to provide further SP criteria that the service coordination system 112 may use during the matching/pairing process. SP criteria can include an individual SP's preferences for qualifications related to users that the service coordination system 112 may validate prior to sending invite notifications to the SP for matching/pairing with users. For example, SP criteria can require that any matched users are above a certain net worth, are interested in investing in a particular area, live in a similar geographic area to the SP, are above a certain age, have a certain level of experience (e.g., investing experience in one or more products or industries), have a certain value or ratio of investments currently, and/or the like. In some embodiments, the SP criteria may be used by the service coordination system 112 to prevent users from contacting or even seeing information related to the SP (for example, through the matching process or otherwise) unless the user meets the SP criteria.

In addition to SP expertise criteria and SP criteria, SPs must also include further information including Personal Identification Information (PII) about themselves to complete their profile. SPs may be required to provide their home address, business address, phone, business phone, years of experiences, licenses, professional designations, certifications, fiduciary/non-fiduciary designation, background, education, and/or the like. This information is used by the system to match and pair users and SPs. Once a SP has completed the registration process and completed their profile, they generally must be verified by the service coordination system 112 before their profile is live on the system and viewable by users. Verification can include identity verification (i.e., verifying an individual SP is who they say they are), professional verification (i.e., verifying an individual SP's credentials), and/or background verification (i.e., verifying that there is nothing in an individual SP's background that would preclude them from joining the service coordination system 112). Further, different verification processes may be required depending on the type of SP and the services being provided. For example, identity and background verification may require a police check, government-issued photo identification verification, submission of original degrees, designations, certifications and/or the like, submission of references, and/or the like. The service coordination system 112 may also review whether any consumer complaints have been logged against individual SPs or if they have committed any crimes that are relevant to their qualification as a SP. The service coordination system 112 may also complete a professional verification of individual SPs such as, for example, requiring degrees, designations, certifications, transcripts and/or the like to be submitted from the issuing institutions. Where a SP claims a professional designation or license, the service coordination system 112 may investigate and confirm the individual SP has the designation/license and is in good standing with the issuing institution. For example, if a SP is a Certified Public Accountant (CPA), the service coordination system 112 may verify the CPA status of an individual SP with the governmental department that issued the CPA designation. In the case of a financial advisor SP, some non-limiting certifications that may be claimed by a SP and reviewed by the service coordination system 112 include: chartered financial analyst (CFA), chartered investment counselor (CIC), certified financial planner (CFP), chartered financial consultant (CFC), retirement income certified professional (RICP), certified public accountant (CPA), certified management accountant (CMA), accredited investment fiduciary (AIF), chartered alternative investment analyst (CAIA), financial risk manager (FRM). The service coordination system 112 may also require that SPs provide evidence of the expertise criteria they claim. For example, if a SP is a financial advisor and claims ESG expertise, the service coordination system 112 may require the SP to illustrate previous ESG portfolio management or demonstrate their expertise is some way to ensure that users are only paired with SPs who have legitimate expertise in the area the user requires. Once a SP has completed the registration and verification process, their profile becomes live on the service coordination system 112 for users to view and the SP becomes eligible to receive invite notifications. As described herein, SP profiles may be viewable by users prior to and/or during the matching process. The SP profiles may also include information such as, a SP written overview/blurb about themselves, certifications/designation, how long an entity (for example, firm) they work for has been in business, how long they have been with the entity, if they or their firm are registered with a securities regulator, what products and services they offer, how they will help a user reach their goals, if they are paid by salary, commission or other fees, how often they expect to meet with users, how they intent to keep user's informed about their investments, references from previous clients, how they decide on appropriate investments for their clients, whether they are licensed to sell any other products, whether they have ever been disciplined by a regulator, whether there have ever been any restrictions, terms or conditions placed on their registration approval, whether they are currently under investigation by a securities regulators, and/or the like.

### D. User and SP Matching Method Overview

FIG. 3A shows a swim-lane flow diagram of an example method for a user to match with and/or create a pairing with a SP using the service coordination system 112. Embodiments of the example method are discussed further and in greater detail with reference to FIGS. 3B, 3C, 4, 5, 6A, and 6B. Certain additional or alternative blocks are depicted in FIGS. 3B, 3C, 4, 5, 6A, and 6B, as indicated in the Figures. It is recognized that there are other embodiments of method of FIG. 3A which may exclude some of the blocks shown and/or may include additional blocks not shown. Additionally, the blocks discussed may be combined, separated into sub-blocks, and/or rearranged to be completed in a different order and/or in parallel.

At block 302, the user generates a meeting request using the user device 102 and transmits the meeting request to service coordination system 112. The meeting request may include data fields that a user completes, via a UI on user device 102. User's may input user criteria (for example, expertise criteria and preferred qualification criteria) into the data fields, that the service coordination system 112 can use to select a suitable number of SPs to match with the user.

In some embodiments, one or both of the user criteria and preferred qualifications may be independently selectable for the individual meeting request and/or may be pulled from a user's profile based on their previous selections. When generating a meeting request, a user may also be able to select meeting times, such as, for example, by selecting blocks of time on a calendar application that indicate when the user is available to meet with a matched SP. For example, a user may indicate that they are available Friday, Mar. 11, 2022, from 6:00 PM to 6:30 PM. In some embodiments, a user may be able to select multiple times and/or large blocks of time when they are available to meet. Blocks of time may be independently selectable by a user or may be pre-generated by the service coordination system 112. For example, the system may only provide fifteen-minute blocks, thirty-minute block, forty-five-minute blocks, hour blocks, and/or the like. Further, the blocks may all be required to start at particular times, such as, for example at the hour or half hour for thirty-minute blocks. A user may be more likely to have a broader pool of SPs to meet with if they select more times.

At block 304, the service coordination system 112 receiving the meeting request from user device 102. The request may be received by, for example, communications component 114 and may contain data that may be stored in one or more of the data stores in service coordination system 112. For example, if the meeting request contains user criteria data, this data may be stored in account data store 204.

At block 306, the service coordination system 112 matches the user data (including user criteria) with the expertise data using, for example, pairing engine 118. The expertise data may include any information from a SP's profile that could be matched with the user data (including user criteria) such as, for example, SP expertise criteria, SP criteria, SP location, SP availability, SP's professional background or designation, SP rating, and/or the like. The matching may include comparing the user criteria to the expertise data for each SP, which may be stored in, for example SP data store 206, to determine which SP profiles include the one or more of the expertise criteria provided in the meeting request. In some embodiments, the matching may also include determining which SP profiles include one or more of the other requirements included in the meeting request. In some embodiments, the matching may also include determining whether the user data matches the SP criteria of potential SPs. For example, if the service coordination system 112 identifies a SP whose profile includes all or some of the requirements of the matching process, the service coordination system 112 may also ensure that the user who submitted the meeting request meets the SP criteria. For example, if a SP requires (based on their SP criteria) that a user has a net worth above $500,000 in order to match with that user, the service coordination system 112 will not include this SP in the first subset unless the user meets the criteria (i.e., has data in their profile that indicates the user's net worth is above the threshold). Based on the comparison, a subset (for example, a first subset) of SPs is generated by the service coordination system 112. For example, in a financial advisor example, if the meeting request required technology investment expertise (user selectable expertise criteria), the first subset generated by the system would include SPs who included this type of expertise in their profile. Generally, the less requirements provided in the meeting request, the greater the number of SPs in the first subset.

In some embodiments, the comparison includes the pairing engine 118 (for example, machine learning component 212) determining base scores that are calculated based on a comparison of individual attributes associated with a user (including the meeting request) and corresponding attributes associated with a SP (and the related SP business as applicable), which may then be normalized and/or otherwise adjusted, such as to assign respective weights to data fields based on the likely (or indicated) importance to the user. For example, in some embodiments, the service coordination system 112 may compare the user generated meeting request (for example, for a financial advisor with technology experience) to services offered by the SP (for example, financial advice related to clean energy), to calculate a base score for that comparison. Additionally, further base scores can be calculated for each criterion included in the meeting request (for example, preferred qualifications related to SP location, years of experience, or the like). In some embodiments, all the base scores can then be normalized or otherwise adjusted and combined by the pairing engine 118 to calculate a matching score for each SP. In some embodiments, users may be able to indicate in the meeting request, the relative importance of each element included (for example, year of experience is valued higher than geographic location). In some embodiments, the meeting request may have pre-set relative importance, such as, for example, highest importance for the expertise criteria included and lower importance for the preferred qualifications. Based on these weightings, the pairing engine 118 may then adjust one or more base scores for certain fields in the meeting request up or down by applying one or more weights that correspond to the user indicated relative importance of each field (or system indicated relative importance). Matching scores can then be compared to the matching threshold value to determine which SPs to transmit invite notifications to and/or include in a list of SPs presented to the user in response to the meeting request.

In some embodiments, matching process of block 306 may be run one or more times with varying matching thresholds until a certain number of SPs are included in the first subset (for example, a feedback loop). The initial matching threshold may require a 100% match of user criteria and expertise data. For example, all SPs included in the first subset may (based on their profile) meet all the requirements of the user criteria. However, if the service coordination system 112 determines that the first subset does not contain enough SPs (for example, there are zero SPs or the threshold criteria cannot be satisfied), the matching threshold may be reduced one or more times (for example, 80%, 60%, or the like) until the service coordination system 112 determines that the first subset contains a sufficient number of SPs. The machine learning component 212 may vary the matching threshold for different users and different meeting requests. The machine learning component 212 may also vary the weight different user criteria is given in determining whether a SP is included in the first subset at a matching threshold less than 100%. The machine learning component 212 may determine that some user criteria is more important than other user criteria (for example, by the user weighting or system weighting). For example, a SP who meets 90% of the user criteria but is missing the only user selected expertise criteria may not be included in the first subset, while a SP who meets only 60% of the user criteria but includes the only user selected expertise criteria may be included in the first subset, especially if the machine learning component 212 determines that the missing user criteria is less relevant. User criteria may be determined to be less relevant if the SP is close to meeting the requirements (for example, located within 20 miles of the user in a meeting request that required 15 miles), based on the machine learning component's 212 assessment of the relevance of certain user criteria, and/or based on the user's indication of relative importance.

At block 308, the service coordination system 112 may rank the SPs in the subset using, for example, ranking component 210. The ranking may include comparing additional user criteria, such as, for example, user preferred qualifications to corresponding information in the SP profiles in the subset. For example, where the first subset was generated based only on a comparison of expertise criteria, the ranking can be provided by a comparison of the additional information such as, for example, geographic location. Based on the comparison, the subset of SPs may be reorganized based on a determination by the service coordination system 112 of which SPs are the most compatible with the user (for example, highest matching score). For example, the SP who is determined by the system to be most compatible with the user may be ranked first, the next best may be ranked second, and so forth. Ranking may be beneficial where a large subset of SPs is generated by the meeting request, such as, for example, by a selection of one broad expertise criteria to provide better matches for the user. The machine learning component 212 may also be used in the ranking process by, for example, adjusting the weight each preferred qualification gets in the ranking process based on previous successful pairings. Where no preferred qualifications are provided, the ranking process of block 308 may be skipped. In some embodiments, the service coordination system 112 may not rank the SPs and may proceed from block 306 to block 310. It is also recognized that block 306 and 308 may be executed in a different order or at the same time.

At block 310, the service coordination system 112 creates a second subset using, for example, by applying the threshold criteria to the first subset. The threshold criteria is used to limit the number of SPs (for example, create a subset) who receive an invite notification. The threshold criteria may be applied automatically by the service coordination system 112 or the user may be able to select which threshold criteria is applied. For example, a user may have been given the option to select a threshold criteria when generating the meeting request at block 302. There may be one or more options for the threshold criteria. In one example, a selectable threshold criteria may be a time response criteria. A time response criteria is used by the service coordination system 112 to create a subset of SPs for presenting to a user based on the response time of the SPs to an invite alert. For example, a time response criteria may limit the number of SPs that are presented to a user in response to a meeting request based on the first select number of SPs that respond to the invite alert. For example, the first 1, 2, 5, 10, 15, 20, 25, 50, and/or the like SPs to respond may be presented to the user. In some embodiments, the user may select the select number when generating the meeting request, while in other embodiments, the service coordination system 112 may have a preset select number. To reduce the number of invite alerts received by SPs and to not overburden the computer systems, there may be an upper limit, for example, 25, that may be selected by a user. Where a ranking process was completed at block 308, the meeting invites may be transmitted based on the rankings. For example, if the select number was 10, the highest ranked 10 SPs from the first subset may receive invite notifications.

In another example, the threshold criteria may be a random draw of a select number of SPs. For example, after the service coordination system 112 has created a subset of SPs based on a comparison on the expertise criteria and/or qualification criteria with the SP information at block 308, a select number of SPs may be chosen to receive invite notifications by randomly selecting a select number of SPs remaining (i.e., the SPs in the first subset). Invite notifications are described further below with respect to blocks 312 and 314. For example, if a user input an expertise criteria requiring ESG expertise, the service coordination system 112 may generate a subset of, for example, 1000 SPs with ESG expertise. Using the random draw threshold criteria, a select number, such as, for example, 25 SPs may be selected to create a subset of SPs to receive invite notifications. In some embodiments, the random draw may be applied before the invite notification is sent to the selected SPs. In another embodiment, a random selection of SPs may be selected to generate a subset based on the SPs that accepted the invite notification. In some embodiments, the user may select the select number used for the random draw, while in other embodiments, the service coordination system 112 may have a preset number.

In some embodiments, a user may be able to apply a threshold criteria without providing any expertise and/or qualification criteria. For example, a user may not have any specific requirements and may apply the time response criteria in order to generate a subset of SPs without any comparison information. In some embodiments, a user may be able to search for a specific SP to send a meeting request to, such as, for example, reviewing SP profiles by searching within the service coordination system 112 to find a suitable SP to send a meeting request to.

At block 312, the service coordination system 112 may transmit a notification, such as, for example, an invite notification/alert to the SP devices 104 associated with the SPs in the second subset. The invite notification may be a text, call, email, in-app alert, platform notification, and/or the like that indicates that the SP has been selected as a potential candidate to match with a user. Generally, the invite notification will provide the SP with two option: to accept or reject the invite. The invite notification may also include additional information such as, for example, the proposed time(s) for the meeting, the expected services to be performed by the SP, and/or the like. In some embodiments, the invite notification may also provide information about the user, while in other embodiments, the user information may be hidden from the SP.

At block 314, a SP receives via SP device 104 a notification from service coordination system 112 which may indicate that the SP was selected as a potential candidate to match with a user. The notification may include further information such as, for example, one or more times when the user would like to meet, information about the user, and/or the like. Depending on the threshold criteria being applied, the timeliness of a SP's response may impact whether they are included in the SP list transmitted to the user at block 324. For example, where the threshold criteria was a time response criteria, only the first set number of SPs who accepted the invite notification would be included in the SP list. If the service coordination system 112 determines that the set number has been met, no more acceptance responses would be accepted by the system and the SPs may be further updated. For example, where the SP list is full, the invite notification may disappear from the SP's user interface, or the SP may receive a further update indicating that the potential match is no longer available. In some embodiments, invite notification may indicate that there is a time response criteria for the particular invite.

At block 316, a SP uses SP device 104 to generate and transmit a response to service coordination system 112. The response may include a selection of whether the SP accepts or rejects the invite alert. For example, if the SP would like to be considered as a match for the user, the SP would accept the alert and if the SP would like to not be considered as a match for the user, the SP may reject the alert.

In some embodiments, when the invite notification includes more than one proposed meeting times, SPs may be able to select one or more of the times as their preferred meeting time. For example, if an invite notification includes meeting times of February 7^{th}-February 10^{th} from 4:00 PM to 6:00 PM, the SP may be able to choose the meeting time when they accept the invitation. For example, the SP could select 5:30 PM on February 9^{th} as the meeting time when they transmit the acceptance response to the service coordination system 112. The SP selection may impact the calendar data they receive at block 320. For example, rather than receiving calendar data for each potential meeting time, the SP may receive calendar data that relates to the selected meeting time as described further herein.

At block 318, the service coordination system 112 receives some or all of the responses from the various SP devices 104 that were in the second subset. For example, some of the responses may have been acceptance responses, some of the responses may have been rejection responses, and some SPs may not have responded at all. In some embodiments, the service coordination system 112 may have one or more waiting times prior to proceeding to block 320. For example, the service coordination system 112 may wait until all of the responses are received from the SP devices 104, a percentage of responses, such as, for example, 20%, 25%, 40%, 50%, 75%, and/or the like are received from the SP devices 104, a specific number of responses, such as, 2, 3, 4, 5, 8, 10, 12, 15, 20, 25, and/or the like are received from the SP devices 104 before proceeding to block 320. In another example, the service coordination system 112 may wait a certain amount of time such as, for example, 15 minutes, 30 minutes, 1 hour, 2 hours, 6 hours, 12 hours, 1 day, and/or the like before proceeding to block 320. In another example, the waiting time may be variable for individual users and may be determined by, for example, machine learning component 212. For example, if a user requested a meeting within a short period of time, the waiting period may be reduced in order to ensure that the matching process is completed prior to the suggested meeting time. Conversely, if a user requested a meeting time much later than the date the user transmitted the meeting request, the service coordination system 112 may extend the waiting time to give the user more SP options to review prior to the meeting. The service coordination system 112 may also factor in the user criteria and threshold criteria in determining the waiting time. For example, if a user wanted to review a certain number of SP profiles, the service coordination system 112 may adjust the waiting time until a threshold number of SPs have responded. However, the machine learning component 212 may accelerate the waiting time even if the threshold had not been met if, for example, the meeting time was soon, the number of invite notifications sent was similar to the threshold, and/or the like.

At block 320, based in part on the SP responses, the service coordination system 112 generates a SP list based on the acceptance responses received from the SP device 104 at block 318. The service coordination system 112 also generates and transmits calendar data using, for example, scheduling component 216. The SP list may include SPs who meet some or all of the requirements submitted by the user in the meeting request or the SPs who accepted the invite notification and are determined by the service coordination system 112 to be the closest matches for the user. In some embodiments, the SP list may contain SPs who are available to meet with a user based on the time blocks selected in the user's meeting request as discussed with reference to block 302. The calendar data may include, for example, data configured to create a tentative meeting request/calendar block on the SP calendars. For example, the User may have selected one or more meeting times when they transmitted the meeting request at block 302. The calendar data may be configured to block a specific time on the SP devices 104 calendars to indicate a potential meeting time. The calendar data may also block or prevent the SP device 104 from receiving any user meeting requests that correspond to that specific block of time. For example, if the meeting request was for January 14 at 5:00 PM, at block 320, the service coordination system 112 may generate calendar data that blocks a certain amount of time (for example, 15 minutes, 30 minutes, and/or the like) on the SP devices 104 who accepted the invite notification at block 316. Subsequently, the SP devices 104 would not receive invite notifications for meeting request that conflict with that same time until the calendar block is removed. Where the threshold criteria applied only includes the first SP to respond to the invite notification, the service coordination system 112 may not generate an SP list and the process may proceed to block 334.

In an embodiment where SPs are able to select one or more meeting times in the response to the invite notification, the calendar data received at block 322 may only block the selected meeting time(s). Rather than block all the suggested meeting times, the service coordination system 112 may only block the time(s) chosen by the SP in response to the invite notification. This process allows the SPs calendars to be open to receive more invites in the future rather than having large portions of their calendar blocked. For example, a user may indicate that they are free every day in a week from 9:00 AM to 5:00 PM. If a SP chooses the meeting time for 4:30 PM on the Thursday of that week, their calendar data received from the service coordination system 112 will only block that time period (i.e., 4:30 PM-5:00 PM on Thursday for a half an hour meeting). Where the threshold criteria allows more than one SP to accept the invite notification, each SP may select a different meeting time. Therefore, at block 320, the calendar data generated and transmitted by the service coordination system 112 may differ for each SP, depending on the time(s) the individual SPs selected.

At block 322, the SP devices 104 receive the calendar data and their calendars are updated accordingly. Continuing with the previous example, because the SP devices 104 accepted the invite notification, a corresponding calendar block may be applied to a SPs calendar using, for example, scheduling component 216. The calendar blocks may indicate to a SP that they have a potential meeting with a user at one or more times. In some embodiments, the service coordination system 112 may check for calendar blocks prior to generating a subset of SPs or transmitting invite notification and may prevent a SP with a calendar block from receiving another invite alert that corresponds to that particular time.

At block 324, the service coordination system 112 transmits the SP list to user device 102.

At block 326, the user receives the SP list via user device 102 from service coordination system 112. The SP list may be presented on the user interface (UI) displayed on the user device 102 and may allow the user to conduct an informed review of the SPs the user can select from (for example, allowing the user to review the SPs profile). Generally, the list of SPs will include SPs whose profile matches the closets to the expertise criteria, qualification criteria, and threshold criteria selected by the user. As described herein, sometimes a user may opt for the quickest response time by not inputting any limiting threshold criteria. In that case, the list of SPs may comprise SPs who responded the quickest to the invite alert.

At block 328, the user selects via the user device 102 a SP with whom the user would like to meet with. The user selection is transmitted to the service coordination system 112. In making the selection, the user may be able to review the profiles of the SPs on the list to make an informed selection. Based on the SP profiles, a user may be able to conduct a further analysis of each SP and choose which SP they think would be the best fit. In some embodiments, the list may include a high level summary of each SP highlighting some expertise information and important characteristics so a user can make a selection without further review of each profile. In some embodiments, each SP on the list may have a compatibility score that indicates to the user an estimate of how compatible they would be with the SP based on their profile and the SPs profile as determined by the service coordination system 112 and/or the machine learning component 212.

At block 330, the service coordination system 112 receives the user selection of one SP to meet with. Based on the user selection, the service coordination system 112 determines which SPs were not selected (unselected SPs).

At block 332, the service coordination system 112 generates and transmits calendar data to the unselected SP devices 104. At block 322, the unselected SP devices 104 receive the calendar data and their calendars are updated. The calendar data may be configured to remove the previously applied calendar blocks so that the calendars of the unselected SP devices 104 are updated to not show a meeting time that corresponds to the meeting request of block 302. Subsequently, the unselected SP devices 104 may once again receive meeting requests for those times. A process associated with unselected SPs is described with reference to FIG. 3B.

At block 334, the service coordination system 112 generates calendar data using, for example, scheduling component 216. The calendar data is transmitted to the user device 102 and the selected SP device 104. The calendar data may include a calendar invite which may include a link to a video conference hosted by the service coordination system 112 or instructions on accessing the video conference as described further herein.

In an embodiment where SPs are able to select one or more meeting times in the response to the invite notification, the calendar data transmitted at block 334 corresponds to the meeting time selected by the SP. For example, if the SP chose June 10, at 6:00 PM, the calendar data received by the user and selected SP will identify this time as the meeting time. If the SP selected more than one time in response to the invite notification, the service coordination system 112 may select the meeting time or the process may include additional steps/blocks where the user can make a final meeting time selection.

At block 336, the selected SP device 104 receives a selection notification and calendar data from service coordination system 112. The selection notification indicates to the SP that they have been selected to meet with the user. At block 338, the user device 102 receives the calendar data from service coordination system 112. As discussed further herein, the calendar data may include a modification of the user interfaces on one or both of the user device 102 and selected SP device 104.

At block 340, at or around the scheduled meeting time, the user may initiate a connection via user device 102 with the selected SP device 104 using service coordination system 112 for the meeting. At block 342, at or around the scheduled meeting time, the selected SP may initiate a connection via the SP device 104 with the user device 102 using the service coordination system 112. At block 344, the service coordination system 112 processes the connection between the user device 102 and the SP device 104 for the User-SP meeting such as, for example, by hosting a video conference meeting. As described further herein, the User-SP meeting is a chance for each party to get to know the other party and determine if they would like to proceed to a more formal relationship.

At block 346, following the meeting, the service coordination system 112 generates and transmits pairing options to the user device 102 and the selected SP device 104 using, for example, pairing component 214. The pairing options may include selectable options to accept or reject the other party. As discussed further herein, in some embodiments, both the user and the SP must accept the other party before a pairing can be formed.

At block 348, the SP device 104 receives the pairing request from the service coordination system 112. At block 354, the SP transmits via the SP device 104 a pairing response to accept or reject the user to the service coordination system 112.

At block 350, the user device 102 receives the pairing request from the service coordination system 112. At block 352, the user transmits via the user device 102 a pairing response to accept or reject the SP to the service coordination system 112.

At block 356, the service coordination system 112 receives both pairing responses from the user device 102 and the SP device 104. As described further herein, in some embodiments, both the user and SP must accept each other before the method proceeds to 358. In some embodiments, one or both the user and SP may be able to transmit a request for a further meeting prior to pairing. The service coordination system 112 may then schedule a follow-up meeting between the user and SP by allowing both parties to submit additional times when they are available for a follow-up meeting.

At block 358, after receiving both acceptance responses from the user device 102 and the SP device 104, the service coordination system 112 creates a pairing of the user and the SP and generates notifications to transmit to both devices. In some embodiments, after a successful pairing, the user display may be updated to ascetically match the SP with whom the user has paired with, such as for example, similar color scheme, display of the SP's personal or corporate logo, and/or the like. The user display is described further herein. In some embodiments, the notification may also contain further information or instructions for either party.

At block 360, the user device 102 receives the pairing notification from the service coordination system 112. At block 362, the SP device 104 receives the pairing notification from the service coordination system 112. Once the pairing has been created, the user and SP may be able interact with each other further using, for example, a chat room system of the service coordination system 112 or standard methods of communication (for example, email, phone, or the like).

FIG. 3B shows a swim-lane flow diagram of an example method for a user to match with a SP illustrating the method of FIG. 3A for an unselected SP. It is recognized that there are other embodiments of the method of FIG. 3B which may exclude some of the blocks shown and/or may include additional blocks not shown. Additionally, the blocks discussed may be combined, separated into sub-blocks, and/or rearranged to be completed in a different order and/or in parallel.

The method of FIG. 3B proceeds in the same manner as the method of FIG. 3A from block 302 to block 332, where a SP received and accepted an invite notification related to a meeting request generated by a user device 102. At block 332, the service coordination system 112 generates and transmits calendar data to the unselected SP devices 104.

At block 370, the unselected SP devices 104 receive the calendar data and their calendars are updated. The calendar data may be configured to remove the previously applied calendar blocks so that the calendars of the unselected SP devices 104 are updated to not show a meeting time the corresponds to the meeting request of block 302. Subsequently, the unselected SP devices 104 may once again receive meeting requests for those times. At block 372, the unselected SPs continue to monitor the SP devices 104 for new invite notifications.

FIG. 3C shows a swim-lane flow diagram of an example method for a user to match with a SP illustrating an example where no SPs accept the invite notification. It is recognized that there are other embodiments of method of FIG. 3C which may exclude some of the blocks shown and/or may include additional blocks not shown. Additionally, the blocks discussed may be combined, separated into sub-blocks, and/or rearranged to be completed in a different order and/or in parallel.

The method of FIG. 3C proceeds in the same manner as the method of FIG. 3A from block 302 to block 314, where a user generated a meeting request with user criteria and the service coordination system 112 transmitted invite notifications to the SP devices 104 includes in the second SP subset.

At block 314, a SP receives via SP device 104 a notification from service coordination system 112 which may indicate that the SP was selected as a potential candidate to match with a user. The notification may include further information such as, for example, one or more times when the user would like to meet, information about the user, and/or the like.

At block 380, a SP uses SP device 104 to generate and transmit a rejection response to service coordination system 112. The rejection response includes a SP selection indicating the SP's rejection of the user. A SP may reject a user for numerous reasons. For example, the SP may have a busy day during the suggested meeting day shown in the invite notification, the user may not be the type of client the SP is currently looking, the SP may be busy during the suggested meeting time but may not have updated their calendar to reflect that, and/or the like.

At block 382, having rejected the invite notification, SPs can continue to monitor the SP devices 104 for new invite notifications.

At block 384, the service coordination system 112 receives some or all of the responses from the SPs indicating that the SPs rejected the invite notification. As described with reference to FIG. 3A, the service coordination system 112 may apply a waiting period prior to proceeding to block 386. In this example, the service coordination system 112 or machine learning component 212 may adjust the waiting period having only received rejection responses. For example, the waiting period may have been conditionally set for 5 responses, 1 hour, 50% responses, and/or the like, but having received only rejection responses, the service coordination system 112 may adjust the waiting period.

At block 386, the service coordination system 112 determines that no SPs have accepted the invite (for example, having received a rejection response for each invite notification sent) or that the invite notifications have lapsed. Like the waiting period, the service coordination system 112 may have a set or variable time by which it determines that the invite notifications have lapsed, such as, for example, 1 hour, 2 hours, 6 hours, 12 hours, 1 day, 2 days, and/or the like. The lapse time may be different for each meeting request and may be determined by the machine learning component 212. For example, in an area with limited SPs, the lapse time may be longer to account for the limited number of potential matches. Conversely, in an area with numerous SPs, the lapse time may be shorter.

At block 388, the service coordination system 112 generates and transmits a notification and prompt that includes an option to find a new SP to the user device 102.

At block 390, the user receive the notification and prompt via the user device 102. The notification may indicate that the service coordination system 112 was unable to find any available SPs to match with the user. The notification may also include further information for the user. For example, there may be an explanation or suggestion of why the user had a difficult time finding a match and/or suggestions on how to increase the chances of finding a match in the future. In some embodiments, the service coordination system 112 may generate specific reasons for why the user's meeting request was rejected and specific user suggestions on how to improve their next meeting request using, for example, machine learning component 212. Having received the notification, the user may be presented with a prompt via the user device 102 that gives the user one or more options. For example, a first option may be to do nothing, and a second option may be to find a new SP to match with.

At block 392, the user selected the “do nothing” option or did not select an option.

At block 394, the user selected the option to find a new SP via the user device 102. Based on this selection, the user device 102 transmits the selection to the service coordination system 112.

At block 396, the service coordination system 112 receives the user's selection to find a new SP and generates a new meeting request UI for the user device 102.

At block 398, the method proceeds to block 302 in FIG. 3A, 3B, or 3C.

### E. Example User Flow

FIG. 4 shows a flow diagram illustrating an embodiment of a matching and/or pairing process of a user and a SP from a user's perspective. It is recognized that there are other embodiments of the process which may exclude some of the blocks shown and/or may include additional blocks not shown. Additionally, the blocks discussed may be combined, separated into sub-blocks, and/or rearranged to be completed in a different order and/or in parallel.

In some embodiments, and generally, prior to completing the matching process, a user will have created a user profile as described above, for example. In some embodiments, the user may then log on to the service coordination system 112 and access a meeting request portion of the user interface. A user may begin the matching process at block 402 by receiving via the user UI a meeting request on user devices 102, completing the meeting request (for example, selecting the desired expertise criteria, choosing meeting times, and/or the like) and transmitting the request to service coordination system 112 (for example, to communications component 114) to be matched with one or more SPs. The meeting request may include a user's criteria (for example, expertise criteria and preferred qualification criteria).

At block 404, the user receives via user device 102, a list of SPs from the service coordination system 112. As described with reference to FIG. 3A, the list of SPs includes SPs who meet all or some of the requirements provided in the meeting request. The user may be required to select a SP from the SP list within a certain amount of time before service coordination system 112 terminates the meeting requisition. For example, the SP may be required to make a selection within 15 minutes, 1 hour, 2 hours, 4 hours, 6 hours, 12 hours, 1 day, 2 days, 3 day, 5 day, 7 days, and/or the like. The selection time may vary for different types of SPs the user is trying to match/pair with. For example, a user may be given more time to select a financial advisor than a fitness coach. In some embodiments, the service coordination system 112 may send reminder notifications to the user device 102 to remind the user to make a selection. The service coordination system 112 may also send warning notifications to the user device 102 to indicate to the user that, for example, time is running out to make a selection and the meeting request will terminate if the user does not make a selection in time. The selection time may also vary based on the proposed meeting time(s). For example, a user may be required to make a selection within a certain amount of time prior to the meeting, such as, for example, 15 minutes, 30 minutes, 45 minutes, 1 hour, 1.5 hours, 2 hours, and/or the like in order to give the selected SP time to prepare for the meeting.

At block 406, the user selects one SP via the user devices 102 to transmit to the service coordination system 112. In making the selection, the user may be able to review the profiles of the SPs on the list to make an informed selection. Based on the SP profiles, a user may be able to conduct a further analysis of each SP and choose which SP they think would be the best fit. In some embodiments, the list may include a high level summary of each SP highlighting some expertise information and important characteristics so a user can make a selection without further review of each profile.

At block 408, the user receives via the user device 102, calendar data that includes a meeting time to meet with the selected SP from the service coordination system 112. In some embodiments, the calendar data may be transmitted in a notification such as one or more of: a text, call, email, in-app alert, platform notification, and/or the like. In some embodiments, the calendar data may include a calendar file that can automatically updates a calendar associated with the user device 102. The calendar data may include instructions on how to meet with the SP and a date and time for the meeting. In some embodiments, the calendar data may include a link to a video conference on the service coordination system 112 that a user can click to access the meeting or instructions on accessing the video conference hosted by the service coordination system 112.

At block 410, the user initiates a connection of the user device 102 with the SP device 104 corresponding to the selected SP via the service coordination system 112 to facilitate a meeting. In some embodiments, the meeting comprises a video conference call on the service coordination system 112 using, for example, video conferencing component 224. However, in some embodiments, the meeting may comprise a telephone call, an in-person meeting, a virtual reality meeting, and/or the like. During the meeting, the user and SP are given the opportunity to discuss the user's needs, the services that can be provided by the SP, and determine whether they are a good match for each other. In some embodiments, the user and SP may be given the option to schedule a follow-up meeting before proceeding to block 412, if, for example, one or both parties think a follow-up meeting would be desirable.

At block 412, following the meeting, the user receives via the user device 102 a prompt from the service coordination system 112 that includes a request for the user to select an option either to accept or reject a pairing with the selected SP. The SP may also receive a similar request, where the SP is given the option to accept or reject the user based on the meeting. Similar to the selection time, the user may be required to accept or reject the SP within a certain amount of time, such as, for example, 1 hour, 2 hours, 6 hours, 12 hours, 1 day, 2 days, 3 days, 4 days, 5 days, 7 days, 2 weeks, and/or the like. The selection time period may vary for different types of SPs. In some embodiments, the user may also receive via the user device 102, reminder and warning notifications from the service coordination system 112.

At block 414, the user decides whether to accept or reject the selected SP. If the user transmits a selection to reject the SP, the user proceeds to block 418. If the user transmits a selection to accept the SP, the user proceeds to block 416 and waits for the SP's response. In some embodiments, only the user will be given the option to accept or reject the SP. In that case, if the user accepts the SP, the user proceeds directly to block 420.

At block 416, the service coordination system 112 has received the SPs response to accept or rejected the user. If the selected SP accepted the user by transmitting an acceptance response to the service coordination system 112, the user proceeds to block 420. If the selected SP rejected the user by transmitting a rejection response to the service coordination system 112, the user proceeds to block 418.

At block 420, the user receives a notification from service coordination system 112 that the pairing has been successful. The notification may also include one or more instructions, such as instructions on how to proceed with the relationship. In some embodiments, after a successful pairing, the user display may be updated to ascetically match the SP with whom the user has paired with, such as for example, similar color scheme, display of the SP's personal or corporate logo, and/or the like.

At block 418, the user may receive a notification from the service coordination system 112 that the pairing was not successful. The user may also receive via the user device 102 a prompt from the service coordination system 112 that includes an option to find a new SP. For example, the user may be given the option to find a new SP to meet with by creating a new meeting request. If the user does not make a selection, the method ends. If the user chooses to select the option to find a new SP via the user UI, the user may proceed to block 422. In some embodiments, the service coordination system 112 may also provide the user with a survey where they can provide a review of the SP they met with. For example, the survey may allow the user to provide feedback to the SP indicating why they chose not to pair with the SP which may be used by the SP to improve their likelihood of pairing in the future.

At block 422, the user receives via the UI on user device 102 a request to select a new SP by completing and submitting a new meeting request. In some embodiments, the user may be able to easily resubmit the meeting request by updating the time blocks in the meeting request. In another example, the user may be given the option of selecting a different SP from the list received at block 404. In some embodiments, the user may be able to send a meeting request directly to a SP from the list, where the meeting request may include a selection of one or more time blocks in which the user is available to meet. After transmitting the new meeting request or other option to the service coordination system 112, the method proceeds to block 404.

### F. Example Service Provider (SP) Flow

FIG. 5 shows a flow diagram illustrating an embodiment of a matching and/or pairing process of a user and a SP from a SP's perspective. It is recognized that there are other embodiments of the process which may exclude some of the blocks shown and/or may include additional blocks not shown. Additionally, the blocks discussed may be combined, separated into sub-blocks, and/or rearranged to be completed in a different order and/or in parallel.

Prior to beginning the process shown in FIG. 5, a SP must have registered, created a SP profile, and generally must have been verified by the service coordination system 112. Once the SP has completed these steps, the SP is available to be selected to match and/or pair with different users.

The process begins at block 502, when the SP receives an invite notification from the service coordination system 112. The invite notification indicates that a user has selected the SP as a potential match. The invite notification may also include additional information related to the potential match such as, for example, the meeting time(s) requested, information about the user, and/or the like. In some embodiments, where the SP has provided SP criteria as a requirement of a match, receipt of an invite notification may indicate to the SP that the User who submitted the meeting request meets the SP criteria.

At block 504, the SP transmits via the SP device 104 a response to the invite notification that indicates an acceptance or rejection to the service coordination system 112. If the SP accepts the user at block 505, the SP proceeds to block 506. If the SP rejects the user, the SP proceeds to block 508. As described above, depending on the threshold criteria, the invite notification may be time based and may disappear before the SP has a chance to respond if enough other SPs already accepted the invite notifications they received. In this case, the SP proceeds to block 508.

At block 508, the SP monitors the SP device 104 for new invite notifications and proceeds to block 502 when they receive another invite notification from a new user.

At block 506, the SP receives calendar data via the SP device 104 from the service coordination system 112. The calendar data may be configured to update the SPs calendar on SP device 104 to block off the proposed meeting time with the user. The time is blocked off on the calendar so the SP knows when the potential meeting may be scheduled and to prevent the SP from receiving any invite notification with conflicting meeting times.

At block 510, the SP waits to see if they are selected by the user. If the user rejects the SP (chooses another SP from the SP list instead), the SP proceeds to block 514. If the user accepted the SP, the SP proceeds to block 518.

At block 514, the SP was not selected to meet with the user. The SP receives a notification indicating the rejection by the user from the service coordination system 112. Having not been selected, at block 516, the SP receives updated calendar data from the service coordination system 112. The updated calendar data is configured to remove the calendar block from the SP's calendar so that the SP can see that they are available at the previously blocked proposed meeting time(s). Additionally, once the calendar block is removed, the SP is available to receive new meeting requests from the service coordination system 112. The rejected SP proceeds to block 508, where the SP monitors the SP device 104 for new invite notifications and proceeds to block 502 when they receive another invite notification from a new user.

At block 518, the SP receives a selection notification indicating a user selection and calendar data from the service coordination system 112. The selection notification indicates to the SP that they have been selected to meet with the user. The calendar data modifies the selected SPs calendar to show a meeting at a specific time scheduled with the user. As described further herein, the calendar data may include a modification of the user interfaces on the selected SP device 104.

At block 520, at or around the scheduled meeting time, the selected SP initiates a connection via the SP device 104 with the user device 102 using the service coordination system 112 (for example, using video conferencing component 224). During the meeting, the selected SP and user may discuss the services the SP can provide, what the user is looking for, fees associated with services, and/or the like.

At block 522, following the meeting, the selected SP receives a prompt that includes a request to accept or reject a pairing with the user from the service coordination system 112. The selected SP may have only a certain amount of time to respond to the prompt before it becomes abandoned. For example, if the selected SP did not make a decision within a selection time period, the service coordination system 112 may determine that the selected SP has effectively rejected the user and terminate the match. The selection time period may be, for example, 1 hour, 2 hours, 6 hours, 12 hours, 1 day, 2 days, 3 days, 4 days, 5 days, 7 days, 2 weeks, and/or the like. The selection time period may vary for different types of SPs. The selection time period may also be determined based on the time of the user's selection. Because the user likely needs more time to determine whether or not to accept the selected SP, the SP selection time period may start once the user has accepted the SP. For example, the SP may be required to make a selection (for example, to accept or reject the pairing) within, for example, 1 hour, 2 hours, 4 hours, 6 hours, 12, hours, 1 day, 2 days, and/or the like before the service coordination system 112 terminates the match. In some embodiments, the selected SP may receive reminder notifications that remind the SP to make a selection and/or warning notifications that indicate that the match may terminate if the SP does not make a selection from the service coordination system 112.

At block 524, the selected SP makes a selection via SP device 104 to accept or reject the user. If the selected SP rejects the user or the match is terminated by the service coordination system 112 (because the selected SP's selection time period ran out), the rejected SP proceeds to block 508. As described above, at block 508, the SP monitors the SP device 104 for new invite notifications and proceeds to block 502 when they receive another invite notification from a new user. If the selected SP accepts the user, the selected SP proceeds to block 526.

At block 526, the selected SP waits for the user's pairing decision. If the user rejected the SP, the SP proceeds to block 514, where the SP receives a notification indicating that the SP was not selected to pair with the user from the service coordination system 112. The notification may also include an indication of why the SP was not selected, such as, for example, a SP review survey completed by the user. The rejected SP then proceeds to block 508, where the SP monitors the SP device 104 for new invite notifications and proceeds to block 502 when they receive another invite notification from a new user. If the user accepted the selected SP, the SP proceeds to block 528.

At block 528, the SP receives a notification that the pairing with the user was successful and instructions for next steps from the service coordination system 112. Once the pairing has been created, the user and SP may interact with each other further.

### G. Example Service Coordination System Flow

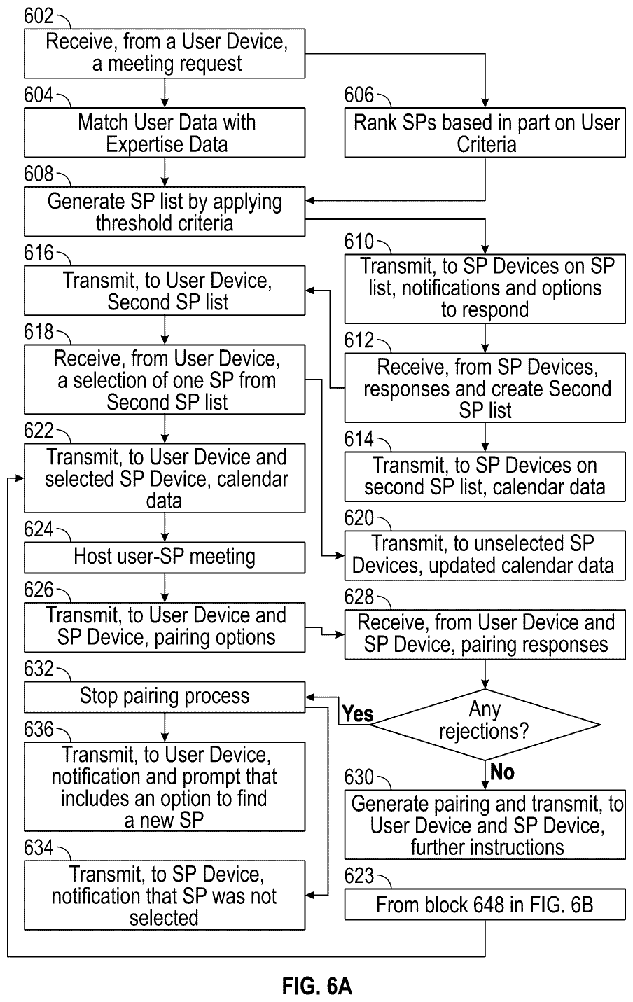

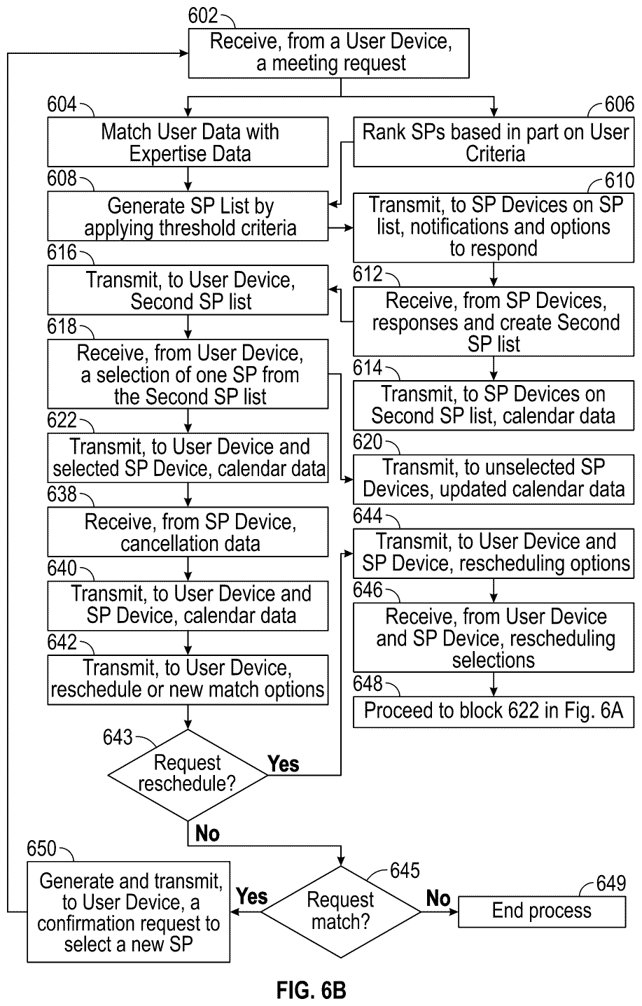

FIG. 6A shows a flow diagram illustrating an embodiment of a matching and/or pairing process of a user and a SP from the perspective of the service coordination system 112. It is recognized that there are other embodiments of the process which may exclude some of the blocks shown and/or may include additional blocks not shown. Additionally, the blocks discussed may be combined, separated into sub-blocks, and/or rearranged to be completed in a different order and/or in parallel.

The matching and/or pairing process begins at block 602 when the service coordination system 112 receives a meeting request from a user device 102. The meeting request may be received by communications component 114 and may be processed by the pairing engine 118.

At block 604, the service coordination system 112 matches the user data (including user criteria) with the expertise data using, for example, pairing engine 118. As described herein, the expertise data may include any information from a SP's profile that could be matched with the user data (including user criteria) such as, for example, SP expertise criteria, SP criteria, SP location, SP availability, SP's professional background or designation, SP rating, and/or the like. The matching may include comparing the user criteria to the expertise data for each SP, which may be stored in, for example SP data store 206, to determine which SP profiles include the one or more of the expertise criteria provided in the meeting request. In some embodiments, the matching may also include determining which SP profiles include one or more of the other requirements included in the meeting request. In some embodiments, the matching may also include determining whether the user data matches the SP criteria of potential SPs. For example, if the service coordination system 112 identifies a SP whose profile includes all the requirements of the matching process, the service coordination system 112 may also ensure that the user who submitted the meeting request meets the SP criteria. For example, if a SP requires (based on their SP criteria) that a user has a net worth above $500,000 in order to match with that user, the service coordination system 112 will no include this SP in the first subset unless the user meets the criteria (i.e., has data in their profile that indicates the user's net worth is above the threshold). Based on the comparison, a subset (for example, a first subset) of SPs is generated by the service coordination system 112.

At block 606, the service coordination system 112 ranks the SPs in the first subset using, for example, ranking component 210. The ranking may include comparing additional user criteria, such as, for example, user preferred qualifications to corresponding information in the SP profiles in the subset. For example, where the first subset was generated based only on a comparison of expertise criteria, the ranking can be provided by a comparison of the additional information such as, for example, geographic location. In another example, where the first subset was generated based on comparison of expertise criteria and additional expertise data, the ranking can be provided by identifying which SPs are most compatible with the user based on the meeting request. The determination may include analysis by the machine learning component 212. Based on the comparison, the first subset of SPs may be reorganized based on a determination by the service coordination system 112 of which SPs are the most compatible with the user. As shown in FIG. 6A, the service coordination system 112 may complete the matching of block 604 and the ranking of block 606 simultaneously or, in some embodiments, may complete the matching and ranking processes in sequence.

In some embodiments, a user may not include any preferred qualifications in their meeting request. In this case, the service coordination system 112 may not complete the ranking process or may rank the SPs based on information the service coordination system 112 determines to likely impact the match, such as, for example, the geographic location of the SPs in the first subset. In some embodiments, a user may not include any user criteria, in which case, the service coordination system 112 may forgo both the ranking and matching process and proceed to block 608.

At block 608, the service coordination system 112 generates a SP list (also referred to as a second subset) by applying the threshold criteria to the first subset. The threshold criteria is used to limit the number of SPs (for example, create a subset) who receive an invite notification. As described with reference to FIG. 3A, the threshold criteria may be applied automatically by the service coordination system 112 or the user may be able to select which threshold criteria is applied. Depending on the number of SPs in the first subset, the threshold criteria may not reduce the number of SPs include in the second subset. For example, if the service coordination system 112 only generated a first subset of 12 SPs based on the user criteria, and the threshold criteria was a random draw of 25 SPs, the first subset and the second subset would be identical. However, if the first subset contained 200 SPs and the same threshold criteria was applied, the second subset would contain 25 SPs randomly selected by the pairing engine 118 from the first subset.

At block 610, the service coordination system 112 transmits invite notifications and options to respond to the SP devices 104 corresponding to the SPs in the second subset (SP List). The invite notification indicates to SPs in the second subset that they have been selected as a potential candidate to match with a user. Generally, the invite notification will provide the SP with two option: to accept or reject the invite. The invite notification may also include additional information such as, for example, the proposed time for the meeting, the expected services to be performed by the SP, and/or the like. In some embodiments, the invite notification may also provide information about the user, while in other embodiments, the user information may be hidden from the SP.

At block 612, the service coordination system 112 receives responses from the SP devices 104 corresponding to the SPs in the second subset that indicate whether the SPs accepted or rejected the invite notification. SPs that accept the invite are included in the second SP list created by the service coordination system 112, while SPs that rejected the invite are not included in the second SP list. The service coordination system 112 does not proceed to block until the pairing engine 118 determines that the second SP list is complete. For example, the second SP list may be complete when the service coordination system 112 has received responses from every SP device 104 that received an invite notification. In another example, the second SP list may be complete when the threshold criteria has been met. For example, if the threshold criteria was a time response criteria limited to five SPs, the second SP list would be completed after five acceptances are received by the service coordination system 112. In yet another example, the second SP list may be complete after the specific waiting time described wither reference to block 318 is completed. For example, if the waiting period was 2 hours, the service coordination system 112 may create the completed second SP list based on SPs who responded within two hours and the service coordination system 112 may not accept acceptance responses from SPs received after that time.

Once the second SP list is completed, the SPs in the second subset who had not responded to the invite notification may no longer be able to response. For example, if the invite notification is displayed on the UI of the SP device 104, once the second SP list is complete, the invite notification corresponding to the specific user may be removed.

In some embodiments, there may be a minimum threshold of SPs that are included on the second SP list. For example, the minimum may be 1, 2, 3, 4, 5, 6, 7, 8, 9, 10, 15, 20, 25, and/or the like. The service coordination system 112 may not proceed to block 616 unless the minimum threshold is hit. In some embodiments, the minimum threshold may be set for by the pairing engine 118, set be the user in creating the meeting request, variable for specific types of SPs, and/or the like. In some embodiments, more invite notifications may be generated by the service coordination system 112 if the minimum threshold is not met. For example, if the applied threshold criteria was the first five SPs to respond and 25 invite notifications were sent with 23 SPs rejecting the invite, the service coordination system 112 may proceed to send out more invite notifications to SPs who were included in the first subset but not the second subset. In this way, the threshold criteria can be met, and the process could proceed to block 614 again for the new SPs who accepted the invite notification and then to block 616.

At block 614, the service coordination system 112 generates and transmits calendar data to SP devices 104 corresponding to SPs on the second SP list using, for example, scheduling component 216. The calendar data may include, for example, data configured to create a tentative meeting request/calendar block on the SP calendars. For example, the user may have selected one or more meeting times when they transmitted the meeting request at block 602. The calendar data may be configured to block a specific time on the SP devices 104 calendars to indicate a potential meeting time. The calendar data may also block or prevent the SP device 104 from receiving any user meeting requests that correspond to that specific block of time. The calendar data may be transmitted by the service coordination system 112 individually for each SP who accepted the invite notification. For example, the calendar data may be transmitted in response to the acceptance response so that the SPs know they are on the second SP list and to prevent the SP from receiving new conflicting invite notifications.

At block 616, once the second SP list is complete, the service coordination system 112 transmits the second SP list to the user device 102 for the user to review. As described herein, if the user does not respond within a certain amount of time as determined by the service coordination system 112, the system may terminate the meeting request and send updated calendar data to the SP devices 104 on the second SP list to indicate the potential match was terminated and remove the calendar blocks.

At block 618, the service coordination system 112 receives a selection of one SP from the second SP list from the user device 102. Based on the selection, the pairing engine 118 determines which SPs from the second SP list are unselected SPs and which SP is the selected SP.

At block 620, the service coordination system 112 generates and transmits updated calendar data to the SP devices 104 corresponding to the unselected SPs. The calendar data may be configured to remove the previously applied calendar blocks so that the calendars of the unselected SP devices 104 are updated to not show a meeting time the corresponds to the meeting request of block 602.

At block 622, the service coordination system 112 generates and transmits calendar data to the user device 102 and the selected SP device 104. The calendar data may include a calendar invite which may include a link or instructions for accessing a video conference hosted by the service coordination system 112 as described further herein. The calendar data also maintains the calendar block on the selected SP's device 104. The calendar data transmitted to the selected SP device 104 may also include a selection notification indicating to the SP that they have been selected to meet with the user.

At block 624, the service coordination system 112 hosts the User-SP meeting using, for example, video conferencing component 224. The video conferencing component 224 may be configured to allow the specific video conference meeting link to be live (for example, user and SP accessible) within a certain amount of time prior to the scheduled meeting time. For example, the meeting may become live 1 minutes, 2 minutes, 3 minutes, 4 minutes, 5 minutes, 10 minutes, 15 minutes, and/or the like prior to the meeting time. When the meeting link is live, the SP and user may join via the SP device 104 and user device 102 respectively.

At block 626, following the completion of the User-SP meeting, the service coordination system 112 transmits pairing options to the user device 102 and the SP device 104. The pairing options may include user selectable options to accept or reject the other party. In some embodiments, both the user and the SP must accept the other party before a pairing can be formed, while in other embodiments, only the user's acceptance is required to form a pairing. In some embodiments, SPs may be able to turn off the pairing requirement so that no pairing response is required and the service coordination system 112 automatically applies an acceptance response to the pairing without transmitting pairing options to the SP device 104. This option may be beneficial to SPs who are not paired with many users and are aggressively looking for pairings.

At block 628, the service coordination system 112 receives the pairing responses from the user device 102 and the SP device 104. The service coordination system 112 determines whether any rejections were received using, for example, pairing component 214. If one or both the User and SP transmitted rejections responses, the service coordination system 112 proceeds to block 632. If both the User and the SP transmitted acceptance responses, the service coordination system 112 proceeds to block 630.

At block 630, both acceptance responses have been received and the service coordination system 112 generates the pairing of the user and the SP and transmits a notification including further instructions to the user device 102 and the SP device 104. The notification may inform the user and SP that they have been successfully paired and may include instructions on how to proceed with the relationship. In some embodiments, when the service coordination system 112 creates a pairing, the system automatically updates the user UI using, for example, visualization component 218, to match some of the elements of the SP UI and illustrate to the user that the pairing has been created.

At block 632, one or both of the user or SP transmitted rejections in response to the pairing options. Based on the rejection response(s), the service coordination system 112 stops the pairing process.

At block 634, the service coordination system 112 transmits a notification to the SP device 104 that indicates that the SP was not selected to pair with the user.

At block 636, the service coordination system 112 transmits a notification and a prompt to the user device 102. The notification informs the user that the pairing was not successful, and the prompt includes a user selectable option to find a new SP as described with reference to block 418 in FIG. 4.

FIG. 6B shows a flow diagram illustrating an embodiment of a matching and/or pairing process of a user and a SP from the perspective of the service coordination system 112. FIG. 6B illustrates the process where a selected SP cancels the scheduled meeting with a user. It is recognized that there are other embodiments of the process which may exclude some of the blocks shown and/or may include additional blocks not shown. Additionally, the blocks discussed may be combined, separated into sub-blocks, and/or rearranged to be completed in a different order and/or in parallel.

The process of FIG. 6B proceeds in the same manner as the process of FIG. 6A from block 602 where the service coordination system 112 receives a meeting request from a user device 102, to block 622, where the service coordination system 112 generates and transmits calendar data to the user device 102 and the selected SP device 104.

At block 638, the service coordination system 112 receives cancellation data from the selected SP device 104. The cancellation data may have been generated on the selected SP device 104 by selecting an option on the SP UI to cancel the upcoming meeting. In some embodiments, the SP may have the option to suggest one or more alternative meeting times for the service coordination system 112 to transmit to the user device 104.

At block 640, the service coordination system 112 transmits calendar data to the user device 102 and the SP device 104. The calendar data is configured to remove the meeting time from both devices and may include a notification that indicates that the SP canceled the meeting.

At block 642, the service coordination system 112 transmits a prompt including reschedule and new match options to the user device 102. The reschedule option may allow the user to suggest one or more times to reschedule the meeting. In some embodiments, the reschedule option may also present the SP's suggested alternative meeting times. The new match option allows the user to request a new match and end the matching process with the current selected SP.

If the service coordination system 112 receives the user selected reschedule option at block 643, the process proceeds to block 644. If the service coordination system 112 does not receive the user selected reschedule option at block 643, the process proceeds to block 645.

At block 644, having received a reschedule selection from the user device 102, the service coordination system 112 transmits rescheduling options to the user device 102 and the selected SP device 104. The rescheduling options may allow one or both of the user and selected SP to select specific and/or ranges of times when they are available to meet. For example, a user may select availability from 4:00 PM-6:00 PM on April 28-April 30 and the SP may select availability from 12:00 PM-8:00 PM on April 28-April 30. Based on the input availability, the service coordination system 112 may determine one or more meeting times that work for both parties' availability, such as, for example, 4:00 PM on April 28. In some embodiments, the rescheduling will be completed by the scheduling component 216 and the system may be configured to select the first available meeting time that works for both parties. In some embodiments, the User and selected SP may be able to use instant message each other using a chat room system of the service coordination system 112 (for example, chatting and logging component 222) to arrange a time to meet that works for both parties. Based on the communication, both parties can input the same reschedule time for the system to generate a new meeting invite.

At block 648, having received the rescheduling selections from the user device 102 and the SP device 104, the process can proceed to block 622 of FIG. 6A, where the service coordination system 112 generates and transmits calendar data corresponding to the new meeting time to the user device 102 and the selected SP device 104.

At block 645, if the service coordination system 112 does not receive a selection or receives a rejection response to the new match option transmitted at block 642, the process proceeds to block 649 where the process ends. If the service coordination system 112 receives a new match selection from the user device 102, the process proceeds to block 650. As described herein, in some embodiments, if no selection is received by the service coordination system 112 within a certain amount of time, the system may terminate the matching process.

At block 650, the service coordination system 112 generates and transmits a confirmation request to select a new SP to the user device 102. The confirmation request may allow the user to generate a new meeting request where the user can select new options (for example, new expertise criteria) or use the same meeting request from block 602 with an option to select new meeting times, new threshold criteria, and/or the like. Following block 650, the process proceeds to block 602 of FIG. 6A or 6B.

### H. Additional Flow Embodiments

In some embodiments, the service coordination system 112 can be used by a user to connect with a SP within a relatively short period of time such as, for example, within 15 minutes of generating a meeting request. However, the time period may be impacted be a number of factors, including: the number of SPs in the user's area, the amount of user criteria included, the type of user criteria included, the time of day the meeting request is transmitted to the system, the time of year the meeting request is transmitted, and/or the like. When a user generates and transmits a meeting request to the service coordination system 112 using user device 102, the user may include user criteria such as, for example, one or more expertise criteria. Instead of selecting one or more meeting times, the user may select an instant meeting option. Based on this selection, the service coordination system 112 may apply threshold criteria that is a time-based response based on the first SP to accept the invite notification. To limit the number of notifications SPs receive regarding potential matches, the service coordination system 112 may only transmit a certain number of invite notifications to SPs who match the user criteria in the meeting request. The number of invite notifications transmitted to SPs may be 5, 10, 15, 20, 25, 50, and/or the like. The machine learning component 212 may adjust the number of invite notifications transmitted based on the number of SPs in the user's area, an assessment of how many invite notifications are generally required to receive one relatively fast response, and/or the like. When the SPs receive the invite notification, the notification indicates that the meeting will take place in the next few minutes. For example, where the invite notification would generally display a meeting time, the notification may present the meeting time as “Now”. Based on this meeting time, the SP can identify that accepting the invite notification will require an instant meeting. The first SP that accepts the invite notification may receive a notification from the service coordination system 112 indicating that they have been selected to meet with a user and may receive calendar data that modifies the SPs calendar to display a meeting within, for example, five minutes of accepting the invite notification. The calendar data may also include a link to the video conference with the user or instructions on accessing the video conference hosted by the service coordination system 112. Similarly, the user may receive calendar data that modifies the User's calendar to display the meeting time and may receive a notification indicating that the meeting request has been accepted and is scheduled to begin at a specific time. The user and SP can then meet using the service coordination system 112 and follow the pairing process identified in FIGS. 3A, 4, 5, and 6A.

In some embodiments, a user may be able to select an instant meeting and when the meeting request is transmitted, the user may be directed directly to the video conference (for example, a new UI or the UI is modified to display the video conference). Similarly, when a SP accepts the invite notification, the SP may be directed directly to the video conference. This process can lead to almost instantaneous meetings with SPs, depending on, for example, the number of SPs using the service coordination system 112 and the general response time of SPs to meeting requests.

In some embodiments, rather than waiting for a meeting with a human SP, a user may be given the option to receive advice from an artificial intelligence (AI) bot. In a financial advisor example, the AI bot may be able to provide similar advice and services as a human financial advisor at an increased response speed and decreased cost. For example, the AI bot may be able to assess the financial health of a user, assist in investing decisions, develop a plan for long-term goals, and/or the like. The AI bots may be provided by machine learning component 212. In some embodiments, users may receive the services of both a human SP and an AI bot. For example, there may be one or more robotic process automations (RPA) implemented by the service coordination system 112 to handle repetitive processes, which may reduce the amount of time SPs have to spend on mundane tasks. Continuing with the financial advisor example, the AI bots may improve the services provided by SPs by managing portfolios in terms of tax efficiency as well as rebalancing portfolios in terms of user goals described further herein. AI bots may also improve the returns of users. Further, AI bots may be used to access overall financial health, financial habits based on financial history, and/or the like.

### I. Computer Systems

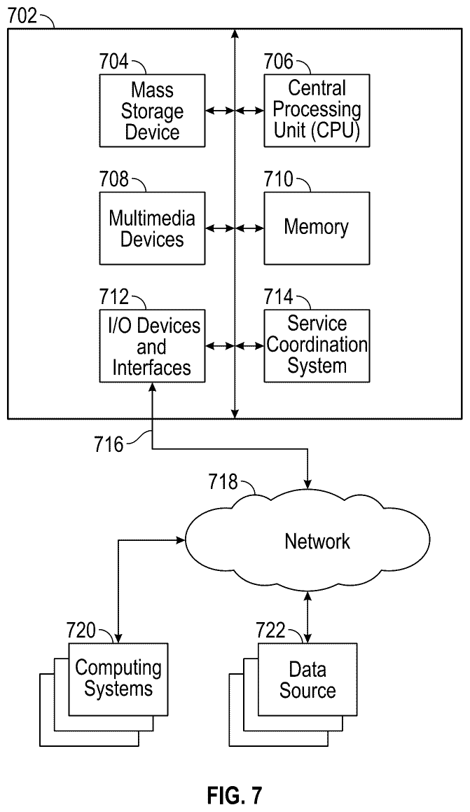

FIG. 7 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 7. The example computer system 702 is in communication with one or more computing systems 720 and/or one or more data sources 722 via one or more networks 718. While FIG. 7 illustrates an embodiment of a computing system 702, it is recognized that the functionality provided for in the components and modules of computer system 702 may be combined into fewer components and modules, or further separated into additional components and modules.

The computer system 702 can comprise a programming module 714 that carries out the functions, methods, acts, and/or processes described herein. The programming module 714 is executed on the computer system 702 by a central processing unit 706 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 702 includes one or more processing units (CPU) 706, which may comprise a microprocessor. The computer system 702 further includes a physical memory 710, such as random-access memory (RAM) for temporary storage of information, a read only memory (ROM) for permanent storage of information, and a mass storage device 704, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 702 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 702 includes one or more input/output (I/O) devices and interfaces 712, such as a keyboard, mouse, touch pad, and printer. The I/O devices and interfaces 712 can include one or more display devices, such as a monitor, which allows the visual presentation of data to a user. More particularly, a display device provides for the presentation of GUIs as application software data, and multi-media presentations, for example. The I/O devices and interfaces 712 can also provide a communications interface to various external devices. The computer system 702 may comprise one or more multi-media devices 708, such as speakers, video cards, graphics accelerators, and microphones, for example.

The computer system 702 may run on a variety of computing devices, such as a server, a Windows server, a Structure Query Language server, a Unix Server, a personal computer, a laptop computer, a smart phone, a personal digital assistant, a tablet, and so forth. Servers may include a variety of servers such as database servers (for example, Oracle, DB2, Informix, Microsoft SQL Server, MySQL, or Ingres), application servers, data loader servers, or web servers. In addition, the servers may run a variety of software for data visualization, distributed file systems, distributed processing, web portals, enterprise workflow, form management, and so forth. In other embodiments, the computer system 702 may run on a cluster computer system, a mainframe computer system and/or other computing system suitable for controlling and/or communicating with large databases, performing high volume transaction processing, and generating reports from large databases. The computing system 702 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 702 illustrated in FIG. 7 is coupled to a network 718, such as a LAN, WAN, or the Internet via a communication link 716 (wired, wireless, or a combination thereof). Network 718 communicates with various computing devices and/or other electronic devices. Network 718 is communicating with one or more computing systems 720 and one or more data sources 722. The programming module 714 may access or may be accessed by computing systems 720 and/or data sources 722 through a web-enabled user access point. Connections may be a direct physical connection, a virtual connection, and other connection type. The web-enabled user access point may comprise a browser module that uses text, graphics, audio, video, and other media to present data and to allow interaction with data via the network 718.

Access to the programming module 714 of the computer system 702 by computing systems 720 and/or by data sources 722 may be through a web-enabled user access point such as the computing systems' 720 or data source's 722 personal computer, cellular phone, smartphone, laptop, tablet computer, e-reader device, audio player, or another device capable of connecting to the network 718. Such a device may have a browser module that is implemented as a module that uses text, graphics, audio, video, and other media to present data and to allow interaction with data via the network 718.

The output module may be implemented as a combination of an all-points addressable display such as a cathode ray tube (CRT), a liquid crystal display (LCD), a plasma display, or other types and/or combinations of displays. The output module may be implemented to communicate with input devices 712 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 702 may comprise a physical or logical connection established between a remote microprocessor and a mainframe host computer for the express purpose of uploading, downloading, or viewing interactive data and databases online in real time. The remote microprocessor may be operated by an entity operating the computer system 702, including the client server systems or the main server system, an/or may be operated by one or more of the data sources 722 and/or one or more of the computing systems 720. In some embodiments, terminal emulation software may be used on the microprocessor for participating in the micro-mainframe link.

In some embodiments, computing systems 720 who are internal to an entity operating the computer system 702 may access the programming module 714 internally as an application or process run by the CPU 706.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL ca specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a web site and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, or the like. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 702 may include one or more internal and/or external data sources (for example, data sources 722). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MogoDB Atlas, Amazon Aurora, Amazon DynamoDB, Amazon Redshift, Amazon ElastiCache, Amazon MemoryDB for Redis, Amazon DocumentDB, Amazon Keyspaces, Amazon EKS, Amazon Neptune, Amazon Timestream, or Amazon QLDB), a non-relational database, or a record-based database.

The computer system 702 may also access one or more databases 722. The databases 722 may be stored in a database or data repository. The computer system 702 may access the one or more databases 722 through a network 718 or may directly access the database or data repository through I/O devices and interfaces 712. The data repository storing the one or more databases 722 may reside within the computer system 702.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As used herein, the terms “determine” or “determining” encompass a wide variety of actions. For example, “determining” may include calculating, computing, processing, deriving, generating, obtaining, looking up (for example, looking up in a table, a database, or another data structure), ascertaining and the like via a hardware element without user intervention. Also, “determining” may include receiving (for example, receiving information), accessing (for example, accessing data in a memory) and the like via a hardware element without user intervention. Also, “determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (for example, transmitting or receiving) information. A message may include a machine-readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, or the like. in multiple parts.

As used herein “receive” or “receiving” may include specific algorithms for obtaining information. For example, receiving may include transmitting a request message for the information. The request message may be transmitted via a network as described above. The request message may be transmitted according to one or more well-defined, machine-readable standards which are known in the art. The request message may be stateful in which case the requesting device and the device to which the request was transmitted maintain a state between requests. The request message may be a stateless request in which case the state information for the request is contained within the messages exchanged between the requesting device and the device serving the request. One example of such state information includes a unique token that can be generated by either the requesting or serving device and included in messages exchanged. For example, the response message may include the state information to indicate what request message caused the serving device to transmit the response message.

As used herein “generate” or “generating” may include specific algorithms for creating information based on or using other input information. Generating may include retrieving the input information such as from memory or as provided input parameters to the hardware performing the generating. After obtained, the generating may include combining the input information. The combination may be performed through specific circuitry configured to provide an output indicating the result of the generating. The combination may be dynamically performed such as through dynamic selection of execution paths based on, for example, the input information, device operational characteristics (for example, hardware resources available, power level, power source, memory levels, network connectivity, bandwidth, and the like). Generating may also include storing the generated information in a memory location. The memory location may be identified as part of the request message that initiates the generating. In some implementations, the generating may return location information identifying where the generated information can be accessed. The location information may include a memory location, network locate, file system location, or the like.

As used herein, “activate” or “activating” may refer to causing or triggering a mechanical, electronic, or electro-mechanical state change to a device. Activation of a device may cause the device, or a feature associated therewith, to change from a first state to a second state. In some implementations, activation may include changing a characteristic from a first state to a second state such as, for example, changing the viewing state of a lens of stereoscopic viewing glasses. Activating may include generating a control message indicating the desired state change and providing the control message to the device to cause the device to change state.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

What is claimed is:

1. A computer-implemented method comprising:
receiving, from a user device, a user request comprising personal identification information (PII) associated with a first user and user criteria;
accessing, from one or more databases, service provider criteria associated with a plurality of service providers;
applying, by one or more computer processors, a trained machine learning model to determine a first set of service providers of the plurality of service providers based at least in part on the user request and the service provider criteria; and
generating and transmitting, to the user device and by a computer network, presentation instructions configured to cause display of the first set of service providers.

2. The computer-implemented method of claim 1, further comprising:
applying threshold criteria to generate a subset of the first set of service providers; and
generating and transmitting to the user device and by the computer network, updated presentation instructions configured to cause display of the subset of the first set of service providers.

3. The computer-implemented method of claim 1, further comprising:
receiving selection of a service provider from the user device.

4. The computer-implemented method of claim 1, wherein the user criteria includes information and data associated with the first user.

5. The computer-implemented method of claim 1, wherein the service provider criteria includes information and data associated with the plurality of service providers, wherein each service provider of the plurality of service providers is associated with respective service provider criteria.

6. The computer-implemented method of claim 1, wherein the training of the machine learning model includes training based on annotated data comprising electronic information pertaining to successful and/or unsuccessful pairings and annotated data comprising electronic information pertaining to a magnitude of success or lack of success in the pairings.

7. The computer-implemented method of claim 2, further comprising:
ranking the subset of the first set of service providers based at least in part on a comparison of the user request and the service provider criteria.

8. The computer-implemented method of claim 1, wherein the user request further comprises one or more time selections.

9. The computer-implemented method of claim 8, wherein the first set of service providers only includes service providers that are available during one of the one or more time selections.

10. The computer-implemented method of claim 2, wherein the threshold criteria comprises a random selection of a select number of the first set of service providers.

11. The computer-implemented method of claim 2, further comprising:
sending an alert to the first set of service providers, wherein the threshold criteria comprises selecting the subset of the first set of service providers based on any responses received from the first set of service providers to the alert.

12. The computer-implemented method of claim 1, wherein each service provider in the plurality of service providers has a rating, wherein the rating is based in part on user feedback.

13. The computer-implemented method of claim 3, further comprising:
scheduling a meeting between the first user and the service provider based on the service provider selection.

14. The computer-implemented method of claim 13, wherein the meeting comprises a video call between the service provider and the first user.

15. The computer-implemented method of claim 13, wherein an alert is sent to both the service provider and the first user prior to the meeting.

16. The computer-implemented method of claim 13, further comprising:
receiving a user response, wherein the user response comprises a selection of a request to pair with the service provider or a selection of a rejection of the service provider;
receiving a service provider response, wherein the service provider response comprises a selection of a request to pair with the first user or a selection of a rejection of the first user; and
creating a pairing if the user response is a request to pair with the service provider and the service provider response is a request to pair with the first user.

17. A system comprising computer-readable memory and one or more computer processors, wherein the system is configured to at least:
electronically receive, from a user device, a user request comprising personal identification information (PII) associated with a first user and user criteria;
access, from one or more databases, service provider criteria associated with a plurality of service providers;
apply, by one or more computer processors, a trained machine learning model to determine a first set of service providers of the plurality of service providers based at least in part on the user request and the service provider criteria; and
generate and electronically transmit, to the user device and by a computer network, presentation instructions configured to cause display of the first set of service providers.

18. The system of claim 17, wherein the system is further configured to:
apply threshold criteria, to generate a subset of the first set of service providers; and
generate and electronically transmit to the user device and by the computer network, updated presentation instructions configured to cause display of the subset of the first set of service providers.

19. The system of claim 17, wherein the system is further configured to receive selection of a service provider from the user device.

20. The system of claim 17, wherein the training of the machine learning model includes training based on annotated data comprising electronic information pertaining to successful and/or unsuccessful pairings and annotated data comprising electronic information pertaining to a magnitude of success or lack of success in the pairings.
